(19) United States
(12) Patent Application Publication
(10) Pub. No.: US 2012/0200657 A1
(43) Pub. Date: Aug. 9, 2012

(54) ELECTRONIC APPARATUS AND STATUS INFORMATION PRESENTING APPARATUS

(75) Inventors: Toshiyuki Iwai, Ichihara-shi (JP); Azusa Umemoto, Souraku-gun (JP); Kaoru Hieda, Chiba-shi (JP); Kanae Naoi, Kyoto-shi (JP); Yu Matsumoto, Yachiyo-shi (JP)

(73) Assignee: Sharp Kabushiki Kaisha, Osaka (JP)

(21) Appl. No.: 13/449,872

(22) Filed: Apr. 18, 2012

Related U.S. Application Data
(63) Continuation of application No. 11/285,225, filed on Nov. 21, 2005.

(30) Foreign Application Priority Data
Nov. 24, 2004 (JP) 2004-339504

(51) Int. Cl. H04N 7/14

(52) U.S. Cl. 348/14.02; 348/E07.077

(57) ABSTRACT

An electronic apparatus has a presence information generator that generates a presence information indicating whether or not a user of the electronic apparatus is in a room or a home in which the electronic apparatus is placed. A power supply outlet of the apparatus supplies power to another electronic appliance. A power supply status detector detects a state of power supply being supplied to the another electronic appliance by the power supply outlet. The presence information generator generates the presence information in accord with the state of power supply to the another electronic appliance, where the status of the power supply is obtained by the power supply status detector.

### CROSS-REFERENCE TO RELATED APPLICATIONS

This application is a continuation of U.S. patent application Ser. No. 11/285,225, filed Nov. 21, 2005, which claims priority under 35 U.S.C. §119(a) to Patent Application No. 2004-339504 filed in Japan on 24 Nov. 2004, the entire contents of which are hereby incorporated by reference.

### BACKGROUND OF THE INVENTION

(1) Field of the Invention

The present invention relates to an electronic apparatus and a status information presenting apparatus, for use in an apparatus such as a cellular phone, videophone, television receiver etc., having a telephonic communication function, which outputs presence information that indicates the status of a user residing near the main apparatus to a telephonic communication party at the other end.

(2) Description of the Prior Art

Nowadays, there has been an emergence of videophones handling video images, to say nothing of the conventional telephones for voice communications. In the conventional telephony system, since there is no way for the caller user to know the callee's status, the caller just starts calling and may start a conversation on the phone if the callee is at home and answers, or may leave a message in the automatic answering system, for example, figuring that the callee is out if there is no answer.

If, however, the caller is able to know the callee's status before making a call, the caller can take a different action. For example, the caller may make communication by email if the callee is out, or may take an action such as calling after a while if the callee is too inconvenienced to answer or does not want to answer for some reason.

Incidentally, the information that indicates the status of an apparatus and its user is called presence information. The term “presence” used here is a concept meaning “status” and “existence”. Specifically, the presence information of a person or party may include his/her profile, residence information, schedule and kinds of devices (PCs, cellular phones, PDAs, etc.) that belong to him/her, and also the “status” on the schedule and the “current situations” of the devices.

Japanese Patent Application Laid-open No. 2004-23374 (Patent reference 1) discloses a device for a cellular phone, with which, the status of a user is informed to another user at the other end, by detecting the operation of the phone, either the open or closed position if it is a folding type, or either extraction or retraction of the antenna, and the like.

In the invention of Patent reference 1, based on the detection result the presence information is generated and notified to the user by displaying a character with a certain expression or other ways. However, this method merely gives notice of the status information of the apparatus itself, to the user at the other end, who just guesses the owner's status. That is, since this apparatus does not explicitly present the owner's status information such as whether he/she is able to answer a call, whether he/she is at home, or the like, the apparatus is still poor in usability.

There is also a need for a presenting means which facilitates users to recognize various status information as to an apparatus or the status information pertaining to the apparatus' owner.

### SUMMARY OF THE INVENTION

In view of the above circumstances, it is therefore an object of the present invention to provide an electronic apparatus and status information presenting apparatus which can guess and present user's status based on various pieces of status information from different components and which can present various pieces of apparatus status information and user status information in a simple and user-understandable manner.

An electronic apparatus of the present invention includes: a status information generator for generating status information; a status information transmitter for transmitting the status information to a status information presenting apparatus connected to a communication network; and a video and audio output portion for outputting input video information or audio information, wherein the status information generator generates the status information pertaining to a user of the electronic apparatus, in accordance with an output status of the video information or the audio information from the video and audio output portion.

With this configuration, the status information pertaining to the user of the electronic apparatus is generated in accordance with the output status of video information or audio information from the video and audio output portion, and the thus generated status information is transmitted to the status information presenting apparatus. Accordingly, the party at the other end, when receiving the status information, is able to know that the user of the electronic apparatus is watching video information or listening to audio information.

An electronic apparatus of the present invention includes: a status information generator for generating status information; a status information transmitter for transmitting the status information to a status information presenting apparatus connected to a communication network; a video and audio output portion for outputting input video information or audio information; and a telephonic communicator for communicating with another apparatus connected to the communication network, wherein the status information generator generates the status information as to whether a communication response using the telephonic communicator is permitted or not, in accordance with an output status of the video information or the audio information from the video and audio output portion.

With this configuration, the status information indicating whether communication response is permitted or not is generated in accordance with the output status of the video information or the audio information from the video and audio output portion, and the thus generated status information is transmitted to the status information presenting apparatus. Accordingly, the party at the other end is able to know that the user of the electronic apparatus cannot respond to a telephonic communication because he/she is watching video information or listening to audio information.

The above electronic apparatus further includes: a power supply status detector for detecting a state of power supply to another appliance, wherein the audio and video output portion outputs a video signal or an audio signal to an outside; and the status information generator generates the status information in accordance with the state of power supply to said another appliance, obtained by the power supply status detector.

With this configuration, the status information is generated in accordance with the state of power supply to another appliance, obtained by the power supply status detector, and the thus generated status information is transmitted to the status information presenting apparatus. Accordingly, the party at the other end is able to know the operating status of the appliance that is supplied with electric power through the electronic apparatus.

An electronic apparatus according to the present invention includes: a status information generator for generating status information; a status information transmitter for transmitting the status information to a status information presenting apparatus connected to a communication network; and an image shooting portion for shooting an image, wherein the status information generator generates the status information pertaining to a user of the electronic apparatus, in accordance with brightness of the image shot by the image shooting portion.

With this configuration, the status information pertaining to the user of the electronic apparatus is generated in accordance with the brightness of the image shot by the image shooting portion, and the thus generated status information is transmitted to the status information presenting apparatus. Accordingly, the party at the other end is able to know the status of the user of the electronic apparatus based on the brightness. For example, information indicating that the user is considered to be present is transmitted when the room illumination is turned on. So the other-end user is able to know that the user of the electronic apparatus is present near the electronic apparatus.

The above electronic apparatus further includes: a video-telephonic communicator for communicating with another apparatus connected to the communication network, and is characterized in that the image shooting portion supplies an image to be transmitted to an apparatus at the other end, to the video-telephonic communicator.

With this configuration, it is possible to detect whether the user is present or not, based on the brightness data that is picked up by the camera as the image shooting portion for a videophone capable of video-telephonic communication.

An electronic apparatus according to the present invention includes: a status information generator for generating status information; a status information transmitter for transmitting the status information to a status information presenting apparatus connected to a communication network; and an audio pickup and input portion for picking up voice and/or sound, wherein the status information generator generates the status information pertaining to a user of the electronic apparatus, in accordance with a level of the voice and/or sound acquired by the audio pickup and input portion.

With this configuration, the party at the other end is able to know the status of the user of the electronic apparatus based on the sound level. For example, information indicating that the user is considered to be present is transmitted when voices and sounds of living are detected. As a result, the other-end user is able to know that the user of the electronic apparatus is present around the electronic apparatus.

The above electronic apparatus further includes: a voice-telephonic communicator for communicating with another apparatus connected to the communication network, wherein the audio pickup and input portion supplies voice and/or sound to be transmitted to an apparatus at the other end, to the voice-telephonic communicator.

With this configuration, it is possible to detect the presence of the user, based on the sound level data that is picked up by the microphone as the audio input portion for the telephone capable of audio telephonic communication.

A status information presenting apparatus according to the present invention includes: a status information receiver for receiving status information from an electronic apparatus connected to a communication network; a status information output portion for outputting the status information received by the status information receiver; a telephonic communicator for communicating with the electronic apparatus connected to the communication network; and a telephonic communication partner selector for selecting an electronic apparatus to be a telephonic communication partner through the telephonic communicator, wherein the status information output portion is allotted so as to output the status information of designated electronic apparatus; the telephonic communication partner selector is allotted so as to be able to select designated electronic apparatus as a communication partner; and the status information output portion is made correspondent to the telephonic communication partner selector.

With this configuration, since the status information output portion is made correspondent to the telephonic communication partner selector, the user is able to select the communication partner whom the user can get in touch with by checking the status information and make telephonic communication with him/her.

The above status information presenting apparatus is characterized in that the status information output portion is marked with an identification symbol for identifying the electronic apparatus; and the telephonic communication partner selector is marked with the identification symbol that is marked on the status information output portion which is made correspondent to the telephonic communication partner selector.

With this configuration, since identification symbols such as, for example A, B, C, etc., are allotted to and marked on the status information output portions and the telephonic communication partner selectors, this facilitates the user to understand the correlation therebetween.

The above status information presenting apparatus is characterized in that the telephonic communication partner selector is provided on a remote control device of the status information presenting apparatus.

With this configuration, since the telephonic communication partner selector is provided on the R/C device, the user is able to operate it separately from the main apparatus and can make control at a position away from the main apparatus.

The above status information presenting apparatus is characterized in that, when the electronic apparatus to be the telephonic communication partner is selected by the telephonic communication partner selector, the telephonic communicator establishes a call that will not receive audio and video from a communication partner, to the electronic apparatus selected by the telephonic communication partner selector.

With this configuration, it is possible to establish a call for one-way communication after confirmation of the communication partner's status information such as his/her presence in the room or other status information.

The above status information presenting apparatus further includes: a telephonic communication-setup deciding portion for deciding whether telephonic communication should be made with another electronic apparatus, wherein, when said another electronic apparatus to be the telephonic communication partner is selected by the telephonic communication partner selector, the telephonic communication-setup deciding portion, based on the status information received by the status information receiver, determines whether the telephonic communication with the electronic apparatus selected by the telephonic communication partner selector should be made or not; and the telephonic communicator performs telephonic communication when the telephonic communication-setup deciding portion has decided to make communication with the selected electronic apparatus.

With this configuration, when, based on the status information the communication partner has been considered to be present near the electronic apparatus at the other end, telephonic communication is determined to be possible. Accordingly, it is possible to set up a telephonic communication after confirmation of the communication partner's presence.

The above status information presenting apparatus further includes: a message transmitter for sending a message to another electronic apparatus, and is characterized in that, when the telephonic communication-setup deciding portion has decided not to make communication with the selected electronic apparatus, the message transmitter transmits a message to the selected electronic apparatus.

With this configuration, when establishment of a telephonic communication with the user of electronic apparatus has been determined to be impossible, a message (email) is sent to the electronic apparatus. Accordingly, it is possible to make a suitable action if the party at the other end is absent.

The above status information presenting apparatus further includes: a voice call-setup deciding portion for deciding whether a call that will not receive audio and video from a communication partner should be established with an electronic apparatus, and is characterized in that, when an electronic apparatus to be the telephonic communication partner is selected by the telephonic communication partner selector, the voice call-setup deciding portion, based on the status information received by the status information receiver, determines whether a call that will not receive audio and video from the communication partner should be established or not; and the telephonic communicator establishes the call that will not receive audio and video from the communication partner when the voice call-setup deciding portion has decided to establish the call that will not receive audio and video from the communication partner.

With this configuration, since a call that will not receive audio and video from the communication partner is established when, for example, based on the status information a person at the other end has been considered to be present near the electronic apparatus, the caller user is able to confirm that the communication partner is watching or listening to the transmitted audio or video even if the caller does not receive audio and video from the other end.

A status information presenting apparatus according to the present invention includes: a video information input portion for receiving video information from an outside; a video information output portion for outputting display information in accordance with the input video information; a status information receiver for receiving status information from an electronic apparatus connected to a network; and a status information output portion for outputting the status information received by the status information receiver, wherein the status information output portion is provided separately from the video information output portion; and the status information output portion provides the status information in a visual manner.

With this configuration, since the status information output portion outputs the status information in a visual manner even while video information is being displayed on the video information output portion, it is possible for the user to immediately grasp the status of the communication partner visually without being disturbed while watching video information.

The above status information presenting apparatus is characterized in that the status information output portion is allotted so as to output status information as to a designated electronic apparatus.

With this configuration, since the status information output portion outputs the status information of the designated electronic apparatus, the user is able to promptly grasp the status information of the designated communication partner.

The above status information presenting apparatus is characterized in that the video information input portion receives a broadcast video program.

With this configuration, it is possible to output the status information pertaining to a communication partner even while a TV-broadcast, etc., is being received and its video program is being displayed.

The above status information presenting apparatus is characterized in that the video information output portion displays display information on a display that is integrally provided with the other components.

With this configuration, since all the components are integrally constructed, it is possible with a single apparatus to perform confirmation of the status information at the same time as performing video display. This configuration thus enables easy handling.

The above status information presenting apparatus is characterized in that the video information output portion outputs display information as a video signal to the outside.

With this configuration, since the video information output portion can output display information to an external appliance, the monitoring apparatus for status information and video display apparatus can be separated.

The above status information presenting apparatus is characterized in that the status information output portion is composed of at least one light emitting device.

Also, the above status information presenting apparatus is characterized in that the status information output portion outputs the status information by flashing the light emitting device.

Further, the above status information presenting apparatus is characterized in that the status information output portion outputs different status information by differentiating the number of times the light emitting device flashes per unit time.

Moreover, the above status information presenting apparatus is characterized in that the status information output portion outputs different status information by differentiating the interval of flashing of the light emitting device.

Still, the above status information presenting apparatus is characterized in that the status information output portion does not flash the light emitting device while the video information output portion outputs display information.

In accordance with these configurations, since the status information can be given notice by the light emitting device, it is possible to distinctly draw the user's attention and inform the user of the status information even when the video display portion is turned off.

Finally, a status information presenting apparatus according to the present invention includes: a video information input portion for receiving video information from an outside; a video information output portion for outputting display information in accordance with the input video information; and a status information receiver for receiving status information from an electronic apparatus connected to a network, wherein the video information output portion superimposes the status information received by the status information receiver over the video information received by the video information input portion.

In accordance with this configuration, since the status information can be displayed on the display screen, being superimposed over the video content, it is possible to draw the user's attention while he/she is watching a video program.

As has been described heretofore, according to the present invention, the user's status information is generated based on a plurality of apparatus statuses information obtained from diverse components, the user is able to obtain more likely status information of the communication partner at the other end, and the user is able to make a suitable action based on the informed user status information, such as making a call immediately, hesitating making a call, sending an email instead, or other actions, hence establish a smooth telephonic communication.

Further, it is possible to give notice of the status information in an easily understandable manner by drawing user's attention with a light emitting device or display without disturbing the user who is watching or listening to some content.

Moreover, when the communication partner is determined not to be in the room or in the home based on the user status information, the apparatus makes call control such as not to establish a call, hence no wasted call will be made.

### BRIEF DESCRIPTION OF THE DRAWINGS

FIG. 1 is an illustrative view showing one example of electronic apparatus according to the present invention;

FIG. 2 is an illustrative view showing one example of a communications system according to the present invention;

FIG. 3 is a component diagram showing one mode of embodiment of a videophone system with an electronic apparatus according to the present invention;

FIG. 4 is an eternal view showing a television receiver;

FIG. 5 is an external view showing a set top unit;

FIGS. 6A and 6B are external views showing an adapter unit;

FIG. 7 is an external view showing a remote control device;

FIG. 8 is a block diagram showing a videophone system configuration;

FIG. 9 is a block diagram showing a configuration of an adapter unit 4;

FIG. 10 is a sequence diagram showing session establishment of one-way communication and two-way communication between videophone terminals;

FIG. 11 is a sequence diagram showing the registering procedures for registration of status notice and registering an apparatus as a response-permitted communication partner apparatus;

FIG. 12 is an illustrative view showing response-permitted terminal information;

FIG. 13 is a view for illustrating example 1;

FIG. 14 is a view for illustrating example 2;

FIG. 15 is a view for illustrating example 3;

FIG. 16 is a view for illustrating example 4;

FIG. 17 is a view for illustrating example 5;

FIG. 18 is a view for illustrating example 6;

FIG. 19 is a view for illustrating example 7;

FIG. 20 is a view for illustrating example 8;

FIG. 21 is a view for illustrating example 9;

FIG. 22 is a view for illustrating example 10;

FIG. 23 is a view for illustrating example 11;

FIG. 24 is a view for illustrating example 12;

FIG. 25 is a view for illustrating example 13;

FIG. 26 is a view for illustrating example 14;

FIG. 27 is a view for illustrating example 15;

FIG. 28 is a view for illustrating example 16;

FIG. 29 is a view for illustrating example 17; and

FIG. 30 is a view for illustrating example 18.

### DESCRIPTION OF THE PREFERRED EMBODIMENTS

The embodiment mode of the present invention will hereinafter be described in detail with reference to the accompanying drawings.

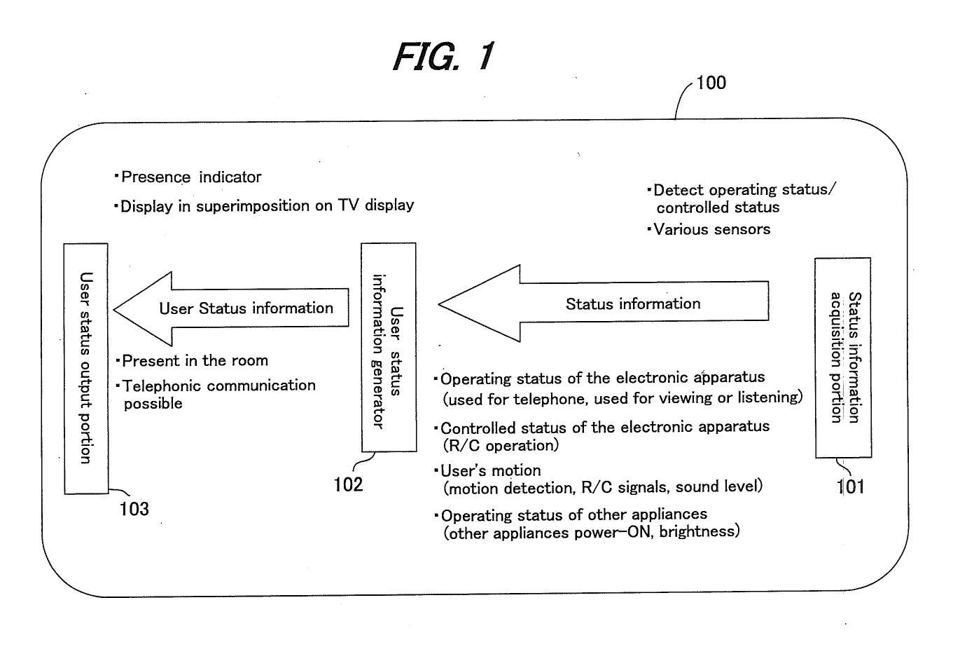

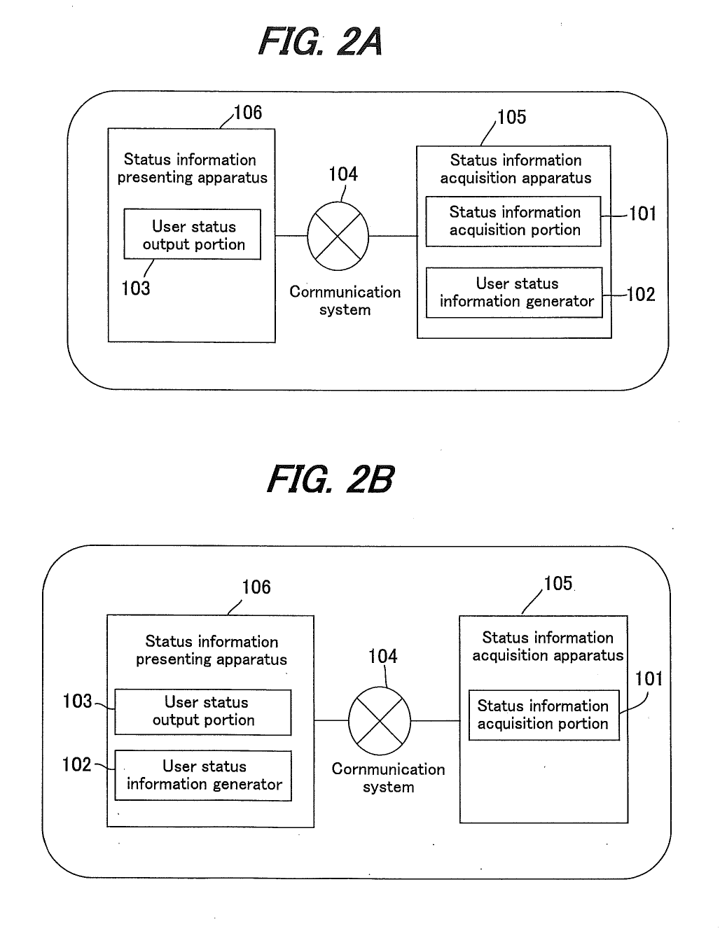

FIG. 1 is a conceptual view showing an electronic apparatus according to the present invention, and FIG. 2 is a conceptual view showing a communications system according to the present invention.

As shown in FIG. 1, an electronic apparatus 100 of the present invention is a television set having a videophone or a telephonic communication function, for example, and includes a status information acquisition portion 101, a user status information generator 102 and a user status output portion 103. Electronic apparatus 100, as will be described later, is constructed so that the user is informed of the presence information pertaining to the communication partner and is able to determine whether to call or whether to communicate by email, by grasping whether the person at the other end is in the room or not.

Status information acquisition portion 101 obtains status information of the apparatus and user by detecting the operating status and controlled status of electronic apparatus 100, directly detecting the user status with various sensors, and/or detecting the operating status of other appliances.

The operating status of the electronic apparatus means, for example, whether the telephonic function is being operated or not, or whether the television function is being used or not.

The controlled status of the electronic apparatus means whether the remote control device is operated or not.

The user status means whether the user is present nearby or not, by detecting a moving object, detecting the presence of a signal from remote control devices, detecting surrounding sound level or brightness.

The operating status of other appliances means the ON/OFF states of power supply to other appliances.

User status information generator 102 judges what state the user is in or whether the user is present near the electronic apparatus, is present not nearby but in the home, or is able to make telephonic communication, from the apparatus status information and user status information acquired by status information acquisition portion 101.

The status information generator includes status information acquisition portion 101 for acquiring various statuses information as to individual apparatus and user status information generator 102 for generating user status information based on the apparatus status information.

A user status output portion 103, based on the judgement of user status information generator 102, turns on and off a presence indicator and/or makes display on the television screen to thereby inform the user of the status of a communication partner at the other end.

Since user status information generator 102 generates user status information based on various apparatus statuses information on different components, it is possible to obtain more likely user status information. Since user status output portion 103 informs the user of the status of the party at the other end, based on the user status information, the user is able to make a suitable action based on informed knowledge, such as making a call immediately, hesitating making a call, sending an email instead, or other actions.

Though the electronic apparatus as 100 shown in FIG. 1 incorporates status information acquisition portion 101, user status information generator 102 and user status output portion 103, the electronic apparatus should not be limited to this. For example, as shown in FIG. 2A, a status information acquisition apparatus 105 composed of status information acquisition portion 101 and user status information generator 102 may be connected with a status information presenting apparatus 106 including user status output portion 103 by way of a network 104, forming a communication system. Alternatively, as shown in FIG. 2B, status information acquisition apparatus 105 including status information acquisition portion 101 may be connected with status information presenting apparatus 106 including user status information generator 102 and user status output portion 103 by way of a network 104, forming a communication system.

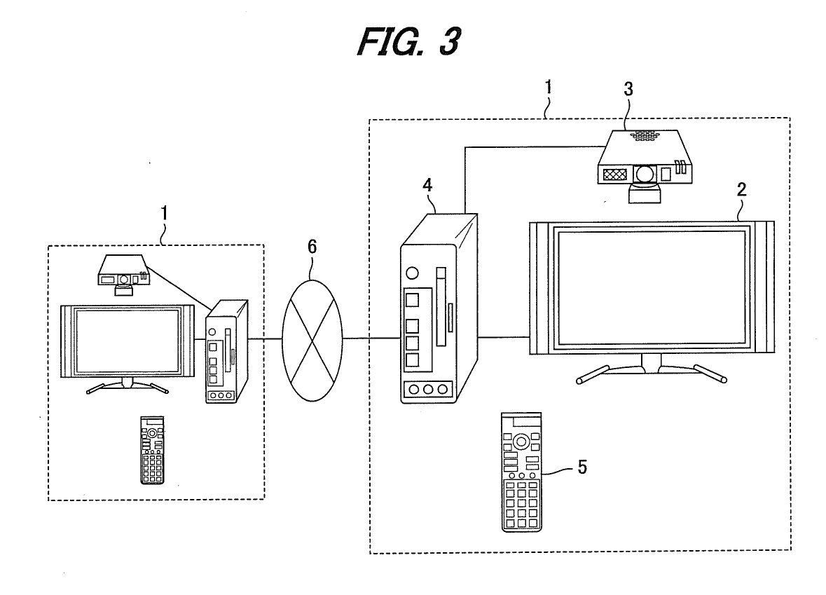

FIG. 3 is a component view showing one embodiment of a videophone system as an electronic apparatus according to the present invention.

This videophone system is composed of, for example, a plurality of videophone apparatuses 1 connected via a network 6. Here in FIG. 3, only two videophone apparatus are depicted, but their number is not limited.

Videophone apparatus 1 as electronic apparatus 100 is composed of a television receiver 2 as user status output portion 103, a set top unit 3 including status information acquisition portion 101 and user status output portion 103 and an adapter unit 4 including status information acquisition portion 101, user status information generator 102 and user status output portion 103, and a remote control device 5.

Though the videophone apparatus 1 of the present embodiment is composed of separate components, i.e., television receiver 2, set top unit 3 and adapter unit 4, being connected by wire, any of two or more components may be combined. Also, transmission of data between these may be implemented by wireless instead of through wire. Remote control device 5 is assumed to use infrared signal transmission, but other kinds of wireless communications may be used, or the control may be made by a wired device.

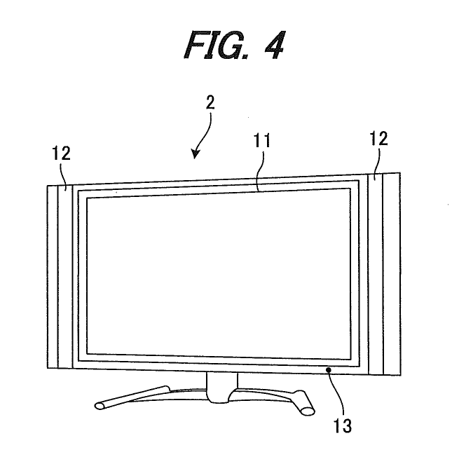

As shown in FIG. 4, television receiver 2 is, for example a LCD television, which is composed of a display (monitor portion) 11 of a LCD panel, speakers 12, a television remote control (R/C) photoreceiver 13 and the like.

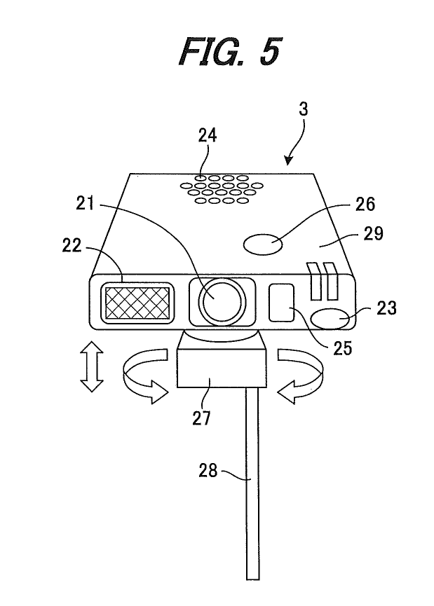

As shown in FIG. 5, set top unit 3 is a unit that is mounted on top of television receiver 2 and provides the videophone function, and includes a camera 21, a microphone 22, a motion detecting sensor 23, a speaker 24, an adapter R/C photoreceiver 25, an incoming call connection button 26, a pan/tilt mechanism 27 for vertical and horizontal movement, a connection cable 28 to be connected to adapter unit 4 (FIG. 3) and an incoming LED indicator 29.

Here, camera 21, microphone 22, motion detecting sensor 23, adapter R/C photoreceiver 25 correspond to status information acquisition portion 101 in FIG. 1, and speakers 24 correspond to user status output portion 103.

Camera 21 provides the function of an image shooting portion for shooting forwards from set top unit 3 and converting the taken image into transmissible communication image data.

Microphone 22 provides the function of audio data converter for picking up voice and sound from the periphery of set top unit 3 and converting the sound into transmissible communication audio data.

Motion detection sensor 23 detects an object that moves in front of set top unit 3.

Speaker 24, based on the input audio data, produces audible sound.

Adapter R/C photoreceiver 25 receives infrared signals from remote control device 5 (FIG. 3).

Incoming call connection button 26 is pressed by the user so that the user is able to respond when the user answers a call from an other-end party.

Pan/tilt mechanism 27 enables set top unit 3 to move vertically and horizontally, and is used to adjust the direction of shooting with camera 21.

Connection cable 28 is to exchange data with adapter unit 4 (FIG. 3).

Incoming LED indicator 29 is composed of an incoming call indicator for indicating the reception of audio and/or image data and an incoming mail indicator for indicating the reception of a mail and flashes on and off to inform the user when a call or mail is received.

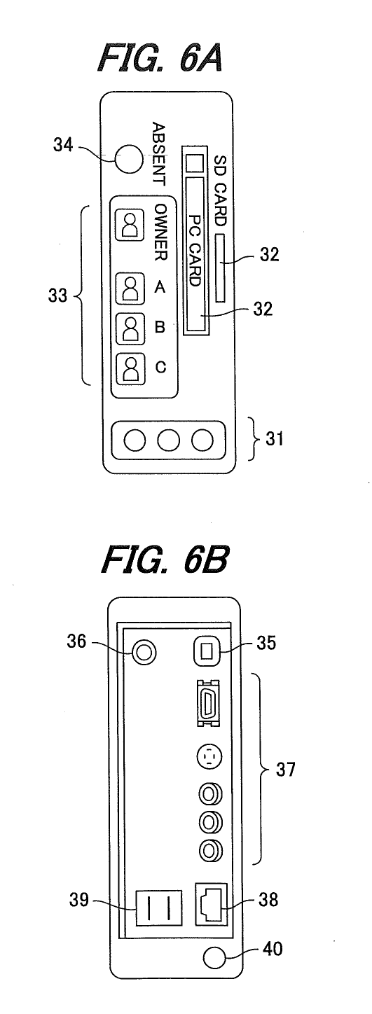

Adapter unit 4 (FIG. 3) is a device that is connected to television receiver 2, set top unit 3 and network 6 to exchange data. This unit has external input terminals 31, card slots 32, presence indicators 33 and an absent button 34 on the front side thereof as shown in FIG. 6A. The rear side includes a connecting terminal 35 for connection with connection cable 28 (FIG. 5) from set top unit 3, an F-type coupler 36, video connecting terminals 37 for connection with television receiver 2, a LAN terminal 38 for receiving a LAN cable, a TV receiver power supply tap 39 and an AC adapter connecting terminal 40, as shown in FIG. 6B.

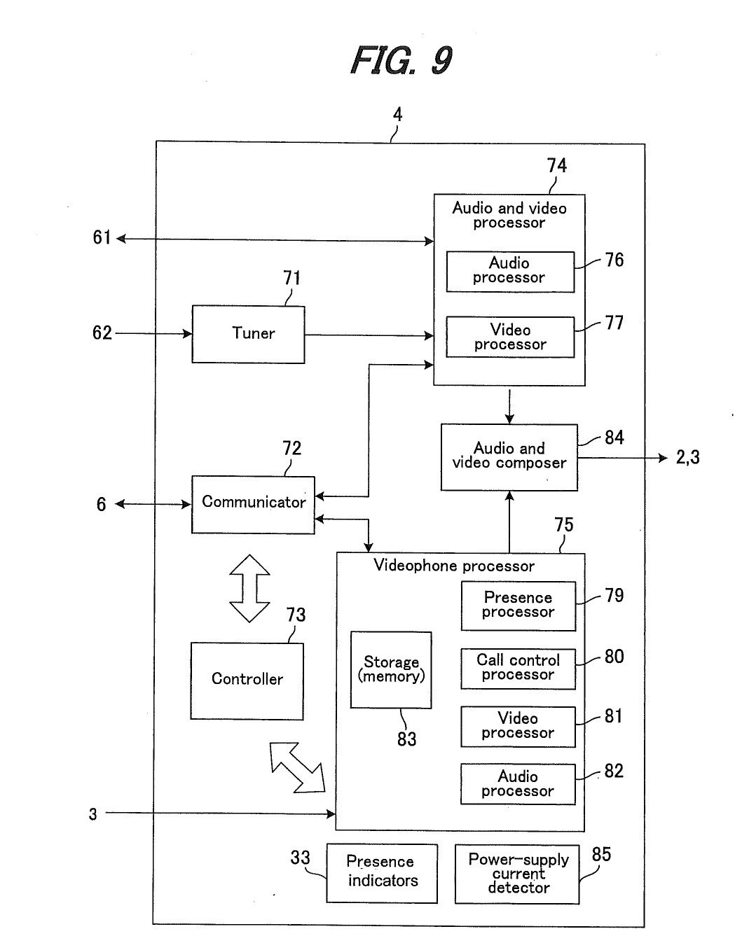

Here, status information acquisition portion 101 (FIG. 1) is constituted of a current detecting sensor 85 (see FIG. 9 described below) disposed in TV receiver power supply tap 39, user status information generator 102 is constituted of a presence processor 79 (see FIG. 9 described below), and user status output portion 103 is constituted of presence indicators 33 (FIG. 6A).

External input terminals 31 (FIG. 6A) are to input video and audio from external devices.

Card slots 32 are to receive SD cards and PC cards and captures files of still images, moving pictures, voice and sounds etc., recorded on memory cards as recording media.

Presence indicators 33 (status information receiver) include a my presence indicator for indicating the presence of the owner and other-end presence indicators for indicating the presence of other-end parties, allotted with A, B and C. As shown in FIG. 6A, three other-end presence indicators, designated by A, B and C, are provided for indicating the presence of three parties, which are each mapped to respective presence indicators at the other end. Accordingly, each presence indicator 33 has the function of indicating whether the owner, or the designated party at the other end, is in the room or in the home or not, and also is able to present the detected status information. Presence indicator 33 may be constituted of light emitting device, so that it can represent the presence by colors and/or the conditions of illumination. Alternatively, it may be given as a LCD unit. When presence indicator 33 is provided as a LCD module, it can also indicate the presence with characters and pictures in addition to colors. Further, instead of providing a plurality of presence indicators for other-end parties, a single LCD unit may be provided, so that the presence information display for A, B and C will change in turn every number of seconds. In this case, character information A, B or C may be displayed while its background color may be adapted to indicate the presence information, correspondingly.

The presence indicators 33 as shown in FIG. 6A are constructed of full-color LEDs, and the status of the owner or the designated other-end party is displayed by the colors of illumination and the extinguished state. It is also possible to use a mono-color LED for presence indicator 33. It is also possible to provide display by using a device other than indicators, such as a LCD device etc.

Though the apparatus of the present invention only includes presence indicators 33 as a means for presenting the status of the other-end apparatus, any means (sound, on-screen display, etc.) other than presence indicators 33 may be used to present the status of the other-end apparatus. Further, if any status change is received, a notice may be given by sound or by on-screen display.

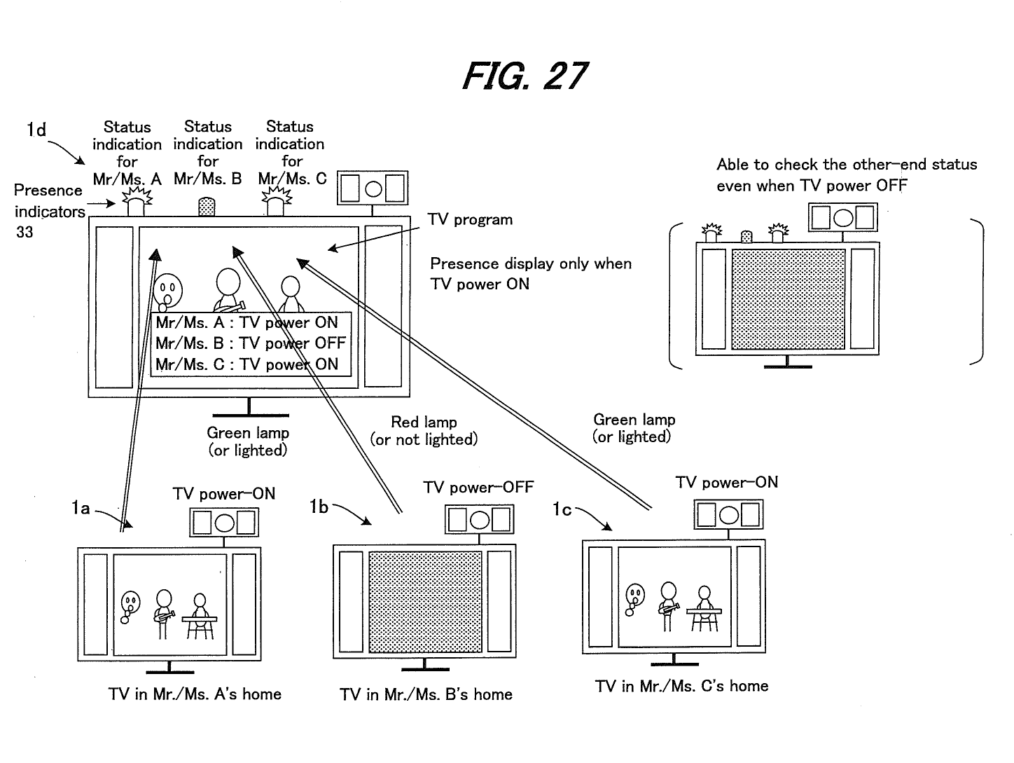

As shown in FIG. 6A, presence indicators 33 are disposed on the front side of adapter unit 4. This is so that the user is able to identify their personal-status and the status of the other-end parties when necessary. As long as the user is able to identify their personal-status and the status of the other-end parties, presence indicators 33 may be provided for set top unit 3 (FIG. 3) instead of adapter unit 4. When television receiver 2 (FIG. 3) and adapter unit 4 are integrated, presence indicators 33 may be disposed on the front side of television receiver 2 or at a position where they can be seen from the front (see FIG. 27 described below).

Pressing absent button 34 (FIG. 6A) once turns the operation status into the absent mode that indicates the user's absence, and pressing once again cancels the absent mode.

Connecting terminal 35 (FIG. 6B) is a terminal that receives connection cable 28 (FIG. 5) from set top unit 3.

F-type coupler 36 is a terminal that receives a connecting line from a TV antenna and is joined to an internal TV tuner.

Connecting terminals 37 are to output video and audio signals to television receiver 2 (FIG. 3).

When videophone apparatus 1 (FIG. 3) is of an integrated type, monitor portion 11 plays the role of a video information output portion. When videophone apparatus 1 is given in a separate form of adapter unit 4 and television receiver 2, connecting terminals 37 correspond to a video information output portion.

LAN terminal 38 (FIG. 6B) is connected to a LAN cable so that the apparatus is connected to a network 6 (FIG. 3) via a router, for example.

TV receiver power supply tap 39 (FIG. 6B) receives an AC plug from the television.

AC adapter connecting terminal 40 is to supply electric power to adapter unit 4 (FIG. 3).

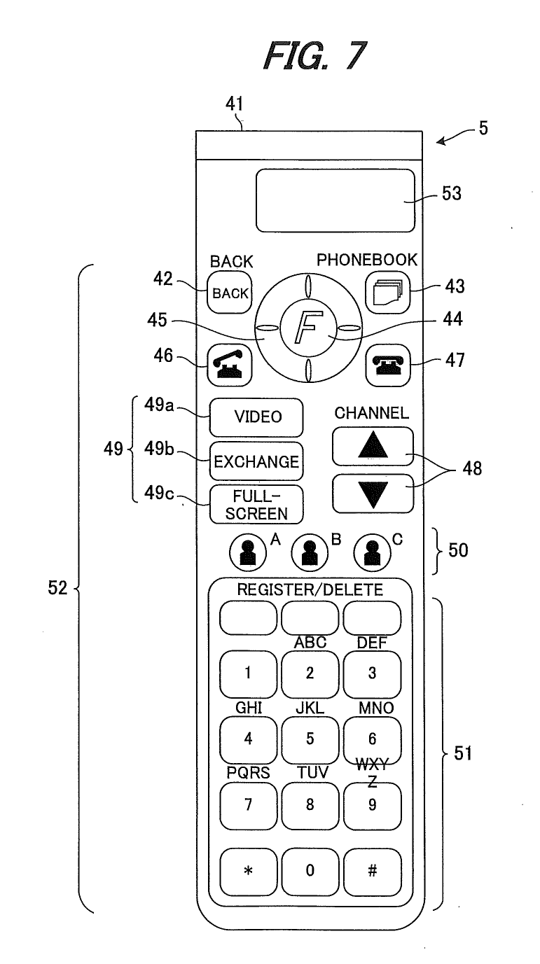

As shown in FIG. 7, remote control device 5 is a device that controls television receiver 2 (FIG. 3) and set top unit 3 from a distance by infrared signals, and includes a light emitter 41 that emits infrared signals in accordance with input to remote control device 5, a control portion 52 and a liquid crystal display 53.

Control portion 52 includes a back key 42, a phonebook key 43, a decision key 44, directional keys 45, a connect key 46, a disconnect key 47, channel switching keys 48, video related keys 49, a voice-call key 50 and numeral/character input keys 51.

Back key 42 is used to go back to the previous menu. Phonebook key 43 is used to call a phonebook frame. Decision key 44 is used to select and determine the item that is highlighted among a plurality of candidates being displayed. Directional keys 45 are used to move the highlight left and right or up and down within the candidate items being displayed. Connect key 46 is used to make a phone call to an endpoint, accept a phone call from an endpoint and answer a voice-call from an endpoint. Disconnect key 47 is used to reject a call from an endpoint, quit a voice-call to an endpoint and stop a voice-call and terminate connection.

Channel switching keys 48 are used to change programs (channels).

Video related keys 49 include a video input key 49a, an exchange key 49b and a full-screen key 49c. Video input key 49a is used when the video to be sent to the other end is switched from the camera input to the input from an external device or from an external device to the camera input. Exchange key 49b is used when the main window and the sub window are exchanged during videophone communication. The full-screen key is used when the output of the sub window is canceled during videophone communication and the main window is displayed full size or when the above full-size display is canceled to return to the display including the main window and sub window. Voice-call keys 50 are used when the persons allotted to the other-end presence indicators are to be called. Numeral/character keys 51 are used to select the channel and input characters.

Voice call key 50 is an example of a communication partner selector. Voice call keys 50 are made correspondent to other endpoints allotted to presence indicators 33 (FIG. 33), and when one of voice call keys 50 is pressed down, a voice call to the associated endpoint is made.

More specifically, the three presence indicators 33 as shown in FIG. 6A are added with symbols A, B and C while the three voice-call keys 50 are also added with symbols A, B and C. That is, the endpoint whose status is shown by presence indicator 33 with a symbol A is identical with the communication partner to be called by using voice-call key 50 with a symbol A. In this way, combination of presence indicator 33 and voice call key 50 related to each other enables the user to make a casual voice call by checking the lighted status of presence indicators 33 and selecting one who is likely to answer.

The symbol allotted to presence indicator 33 may be marked on the presence indicator itself or written near the presence indicator 33. Similarly, the symbol allotted to voice-call key 50 may be marked on the voice-call key itself or written near the voice-call key 50. In this case, the symbols are not necessarily the same. As long as they can be made correspondent to each other, presence indicators 33 may be allotted with uppercase alphabetical letters A, B and C while voice-call keys 50 may be allotted with lowercase alphabetical letters a, b and c. Voice-call keys 50 are not necessarily provided in remote control device 5, but may be disposed in adapter unit 4 (FIG. 3) or set top unit 3. If the voice-call keys are formed in adapter unit 4, presence indicators 33 (FIG. 6) and voice-call keys 50 (FIG. 7) may be formed integrally so that pressing presence indicator 33 with a symbol A makes it possible for the user to make a voice call to the endpoint A. This integration is advantageous in explicating the correlation between presence indicators 33 and voice call keys 50. In contrast, when voice-call keys 50 are separated from presence indicators 33 and formed in remote control device 5, this configuration is advantageous for the user to make a voice-call control close at hand.

Though voice-call key 50 in the present embodiment is used to set up an aftermentioned one-way communication call, it may also be used for setting up a two-way communication call.

It is also possible to provide such an arrangement that a voice-call can be made to an endpoint to which neither presence indicator 33 nor voice-call key 50 is allotted. This can be done, for example, by directly inputting the address by using an endpoint operating control portion 52 (FIG. 7) of remote control device 5. Alternatively, it is possible to provide an arrangement as follows. That is, one or more terminals or parties at the other end to which a communication initiation request may be transmitted have been previously registered as a communication initiation request recipient terminal information in a communication initiation request recipient terminal information storage. Upon transmission of a communication initiation request, the apparatus, in accordance with user instructions, displays a list of the other end terminals stored as communication initiation request recipient terminal information in the communication initiation request recipient terminal information storage, and sends out a communication initiation request to the other-end terminal selected by the user.

Here, a “voice-call” means the function of transmitting voice to the other end in the one-way communication mode without reception of audio and video from the other end. More detailedly, the voice-call indicates a process in which a one-way communication call capable of transmitting voice from the caller side to the callee side is set up by the user operation of remote control device 5 in the videophone apparatus 1 (FIG. 3) on the caller side, so as to transfer the voice from the caller user to the callee's videophone apparatus 1. The videophone apparatus 1 on the callee side will automatically accept establishment of the one-way communication call if the call setup request is from one of the terminals contained in the response-permitted party list without any user operation.

The phrase “quit a voice-call” means that, in caller's videophone apparatus 1, the user disconnects the one-way communication call by operating remote control device 5. The phrase “stop a voice-call” means that, in callee's videophone apparatus 1, the user disconnects the one-way communication call by operating remote control device 5. The phrase “answer a voice-call” means that, in callee's videophone apparatus 1, the user switches the call from one-way communication mode into two-way communication mode by operating remote control device 5. In this case, caller's videophone apparatus 1 should grant a shift of the call from one-way communication mode into two-way communication mode without any user operation.

In the description of the present embodiment, the side that sends out a connection request when a one-way communication call is set up is called “caller side” while the side that receives the connection request is called “callee side”. Accordingly, the side that sends out a request for switching the communication from a one-way call to a two-way call when the mode is changed from one-way communication to two-way communication is not necessarily limited to the caller side. On the contrary in the present invention, in most cases the callee's videophone apparatus 1 will be referred to as the side that sends out a request for switching the communication from a one-way call to a two-way call, so care should be taken.

Network 6 (FIG. 3) may be the Internet, or may be a network such as LAN, WAN or the like. In the present embodiment, the devices are connected by wire but they may be connected by wireless or other means.

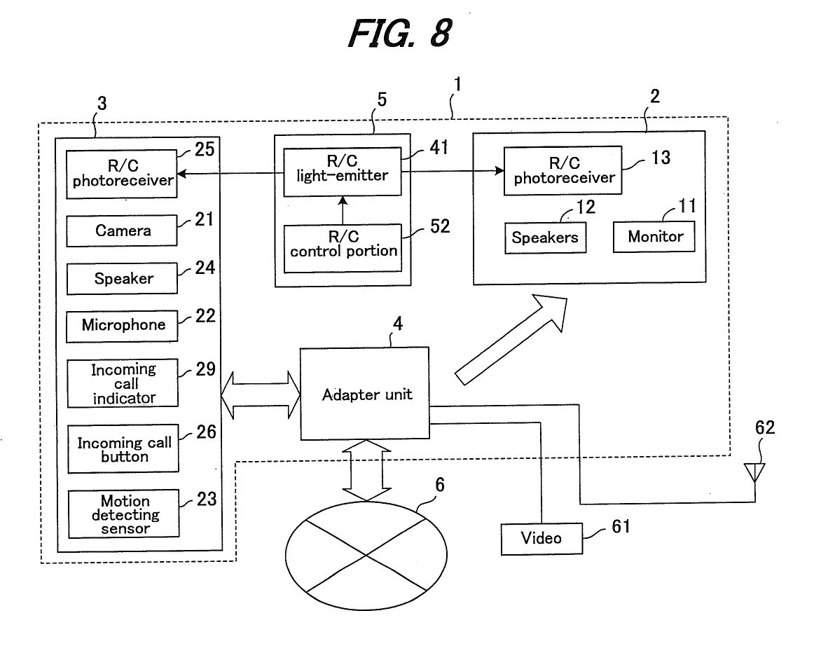

FIG. 8 is a block diagram showing a videophone system configuration. FIG. 9 is a block diagram showing a configuration of adapter unit 4 (FIG. 8). The same components as in FIGS. 3 to 7 are allotted with the same reference numerals with detailed description omitted.

Adapter unit 4 (FIG. 8) inputs image and sound information from external appliance 61 such as a video player or receives TV programs by way of an antenna 62. As shown in FIG. 9, the adapter unit includes a tuner 71, a communicator 72, a controller 73, an audio and video processor 74, a videophone processor 75, presence indicators 33, and a power-supply current detector 85.

Tuner 71 is an example of a video information input portion. Tuner 71 demodulates digital multichannel broadcast signals received through antenna 62 (FIG. 8) to generate a baseband bit stream signal. The bit stream signal output from tuner 71 is input to audio and video processor 74, where a particular video information stream and audio information stream and a particular program information stream are separated from the bit stream signal having a plurality of programs (video information) and a plurality of programs information multiplexed therein. The audio information stream is decoded by a program-audio processor 76, processed through an audio and video composer 84, and output from speakers 12 and 24 (FIG. 8) of television receiver 2 and set top unit 3. The video information stream is decoded by a program-video processor 77 (FIG. 9), processed through audio and video composer 84 and output to television receiver 2 (FIG. 8). The video information output from audio and video composer 84 is supplied to, for example, video input terminals (composite terminal, S-terminal or D-terminal) of television receiver 2.

Video and audio information is also input from external appliance 61 (FIG. 8) and processed in the same manner as above by program-audio processor 76 (FIG. 9) and program-video processor 77. Further, video and audio information is also input via network 6 (FIG. 8) into communicator 72 (FIG. 9) and transferred to audio and video processor 74, where the video and audio information is subjected to the same process as above.

Videophone information is input from, and output to, network 6 via communicator 72. Upon this, videophone processor 75 handles the processing of videophone information. Videophone processor 75 is an example of a telephonic communicator. The term “telephonic communication” includes not only two-way communication such as voice telephony, video-telephony, but also the one-way communication called “voice call” in the present embodiment. Videophone processor 75 functions as an example of a voice telephonic communicator when it handles telephonic communication involving audio, and functions as an example of video telephonic communicator when it handles telephonic communication involving video. Videophone processor 75 includes a presence processor 79, a call control processor 80, an audio processor 81, a video processor 82 and a storage (memory) 83.

Presence processor 79 implements the process of generating user status information as to whether the user is present in room or not and others, from the information obtained from different status information acquisition portions. The thus generated user status information is transmitted to other apparatus via communicator 72 and output to monitor 11 (FIG. 8) and presence indicators 33 (FIG. 9). Presence processor 79 receives the status information of other apparatus via communicator 72 and output it to monitor 11 and/or presence indicators 33. Presence processor 79 as a status information receiver performs a process of receiving status information of other apparatus via communicator 72. Presence processor 79 as a status information transmitter performs a process of transmitting status information to other apparatus via communicator 72.

Call control processor 80 performs establishment of a call. Audio processor 81 and video processor 82 handle processing of audio and video data for video telephony. Storage 83 previously holds the necessary data for call control.

Controller 73 governs the operations of all the components.

Each presence indicator 33 is controlled by controller 73 in accordance with the user status information.

Power-supply current detector 85 detects the current through TV receiver power supply tap 39 (FIG. 6) so as to detect the ON/OFF state of television receiver 2.

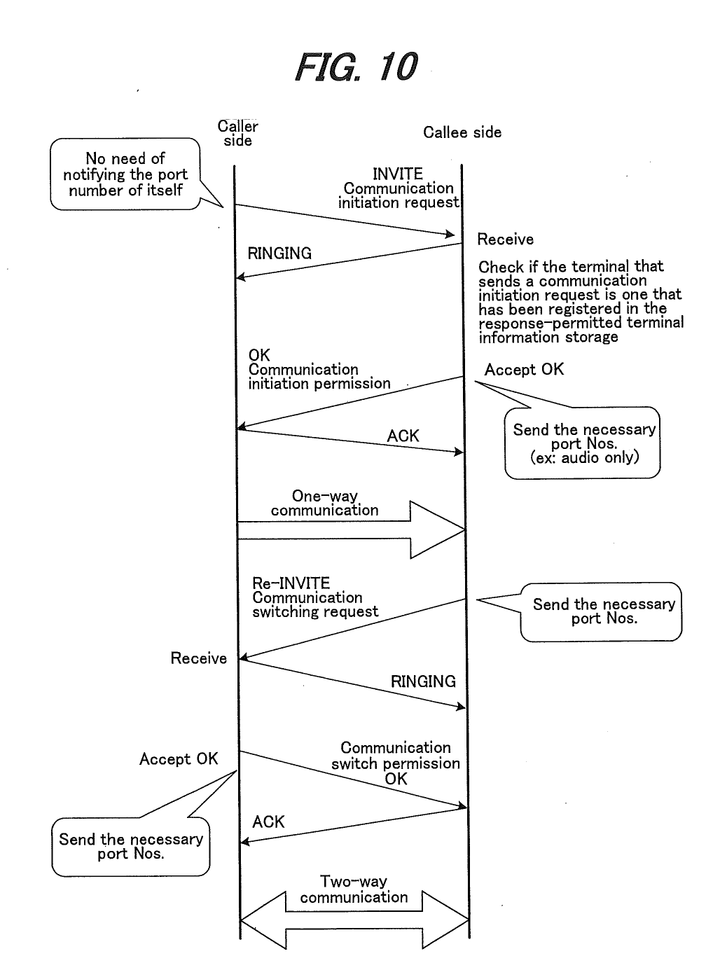

FIG. 10 is a sequence diagram showing session establishment of one-way communication and two-way communication between videophone terminals.

This embodiment assumes that a call is established between the caller's videophone apparatus and the callee's videophone apparatus using SIP (Session Initiation Protocol). Call control processor 80 of videophone processor 75 (FIG. 9) handles this process. When a request relating to call control is made between the caller side and the callee side, a request message is notified from one end to the other, and if the other end responds this request, it sends out a response message to the opposite end. This message is one that is handled automatically by videophones.

Initially, two videophone terminals are not connected to each other. The caller side sends out a communication initiation request “INVITE” for setting up a new session to the callee side. Upon this, communicator 72 (FIG. 9) on the caller side does not need to notify the callee side of communication port number information.

The callee side receives the communication initiation request and sends back a response message “RINGING” which indicates being called. Here, since return of a response message “RINGING” is arbitrary, it is not always necessary to send back the response message “RINGING”.

The callee side checks whether the sender of the communication initiation request is acceptable by referring to the previously setup response-permitted terminal information. As a result of the reference, if the sender terminal is found in the response-permitted terminal information, the callee's call control processor 80 (FIG. 9) notifies the caller side of the communication port number for audio data together with a communication initiation authorization “OK” for acceptance of the communication request.

The caller's call control processor 80 immediately sends out an “ACK” signal that indicates reception of communication initiation authorization “OK” to the callee side.

In this way, one-way communication session for audio data from the caller side to the callee side is established.

If the caller is not included in the response-permitted terminal information in the callee's memory 83, the callee's call control processor 80 sends back a message “NG” which rejects the call setup request from the caller and does not permit establishment of the one-way communication.

There is a case in which communication from the callee to the caller is needed after the establishment of one-way communication. In this case, it is necessary to establish a two-way communication session. For this purpose, first a communication switching request “Re-INVITE” is sent from the callee side to the caller side. The callee side notifies the caller side of the communication port number for video data by the communication switching request. Upon this, the callee side may notify the caller side of the communication port number for audio data once again.

Receiving the communication switching request, the caller side sends back a message “RINGING” which indicates reception of the communication switching request. This “RINGING” may be omitted because it is a tentative reply message before returning “OK” or “NG”.

Then, after making sure that the “Re-INVITE” request is from the endpoint to which the caller has sent a communication initiation request, the caller side gives notice of a communication switch authorization “OK” to the callee side. At this point, the communication port number for audio data and the communication port number of video data are preferably sent. If the request is one that is sent from other than the endpoint to which the caller has sent a communication initiation request before, the caller sends an “NG” signal that indicates rejects switch of communication.

The callee side immediately sends an “ACK” signal that indicates reception of the communication switch authorization to the caller side.

In this way, a two-way communication session of audio data and video data, which also enables communication from the callee side to the caller side is established. In short, video-telephonic communication between the videophone terminals can be enabled.

Though, in the above case, the response message “RINGING” is sent immediately after when the communication initiation request “INVITE” has been received, this notice can be given after a confirmation transaction. It is not necessary to send “RINGING” if unneeded.

Here, the sequence of session establishment shown in FIG. 10 is a mere example of setting up a video-telephonic communication between videophone terminals. Since the aim of the present embodiment is mere establishment of video-telephonic communication, it is possible to provide a simple sequence for establishing a two-way communication session of audio data and video data, by sending the communication port numbers for audio data and video data from the caller to callee sides at the same time when a communication initiation request is sent, then sending back the communication port numbers for audio data and video data from the callee to caller sides when a response to the communication initiation request, for example the communication initiation authorization, is returned. Further, instead of establishment of video-telephonic communication using audio and video, establishment of simple voice-telephonic communication or one-way communication of audio and video may be considered as variations of the present embodiment. In addition, use of SIP as the communication protocol for session establishment is assumed but other communication protocols such as H.323 and others can be used.

Next, the relationship between the presence indicators and response-permitted terminal information will be described.

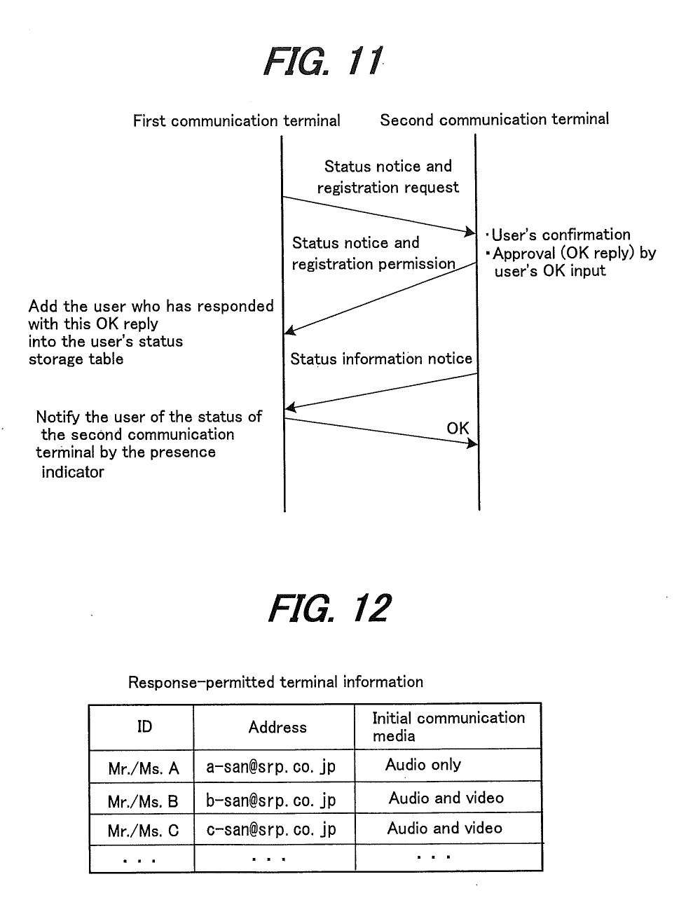

As stated above, the response-permitted terminal information is provided aiming at automatically determining whether a communication initiation request should be accepted, and includes the information as to other-end parties from which a communication initiation request may be accepted. This information is stored in a response-permitted terminal information storage (storage 83 in FIG. 9). Storing an other-end party in this response-permitted terminal information storage as response-permitted terminal information (see FIG. 12), means acceptance of one-way communication from that party without any user instruction when receiving a communication initiation request from that party. As a result, there might occur a case where, though the user's terminal has received a communication initiation request from that other-end party, the user cannot answer the call because the user is inconvenienced. To deal with such a situation, if the user's own state, that is, what status the user is in being busy or absent is notified to the designated other-end party, the user is able to avoid the occurrence of the above case, thus making it possible to accept a communication initiation request from the other-end party and make communication in a more reliable manner. For this reason, it is preferred that the status of other-end terminals is registered following the predetermined procedures with the prior consent from the parties at the other end. It goes without saying that implementation of the reverse procedures is also preferable.

FIG. 11 shows an example of registration of status notice and procedures of status notice. Here, it is assumed that the first communication terminal desires to be given a status notice of the second communication terminal.

First, the first communication terminal sends out a status notice registration request, which includes a request for a notice of the status of the second terminal to the second communication terminal.

When the second communication terminal receives the status notice registration request, it inquires of its own user whether the status notice should be accepted. As approval is input by the user, the second communication terminal registers the first communication terminal as response-permitted terminal information into storage 83 (FIG. 9) and sends back the approval of the status notice registration to the first communication terminal which is the sender of the status notice registration request. Here, it is also possible to consider a case where the information as to whether the status notice is given or not to the first communication terminal has been previously stored in storage 83 of the second communication terminal, and no inquiry to the user will be made when the second terminal receives a status notice registration request.

Thereafter, the second communication terminal, periodically or when any status change occurs, sends a status information notice to the first communication terminal to which the status notice registration has been permitted.

When receiving the status information notice from the second communication terminal, the first communication terminal sends back an “OK” signal as reception acknowledgement information to the second terminal and displays the received status of the second communication terminal to the user by means of presence indicator 33 (FIG. 9). It is of course possible to store the status of the second communication terminal temporarily or over a long period in order to present it on presence indicator 33. This configuration makes it possible for the user of the first communication terminal to know the status information of the second communication terminal by presence indicator 33 and start a call at the proper time in accordance with the second communication terminal's user status.

The status notice registration request in this example can be achieved by a message “Subscribe” if based on SIP. As the status information notice for notifying a status, a message “Notify” can be used. Here, use of SIP as the communication protocol for status information registration and status notice is assumed but other communication protocols can be used. Also, other messages such as “Publish” may be used even if SIP is used.

In connection with the above, in addition to the indication of requesting a notice of the status, the status notice registration request may involve an indication of a request for registering the sender as a terminal to which one-way communication is permitted. In this case, if the status notice registration permission is sent back, not only indicating the permission for status notice but also indicating the permission for one-way communication, the sender user becomes able to set up one-way communication if he/she wants, to the party whose status information is displayed by presence indicator 33.

Next, specific examples of operation with status information will be described.

### Example 1

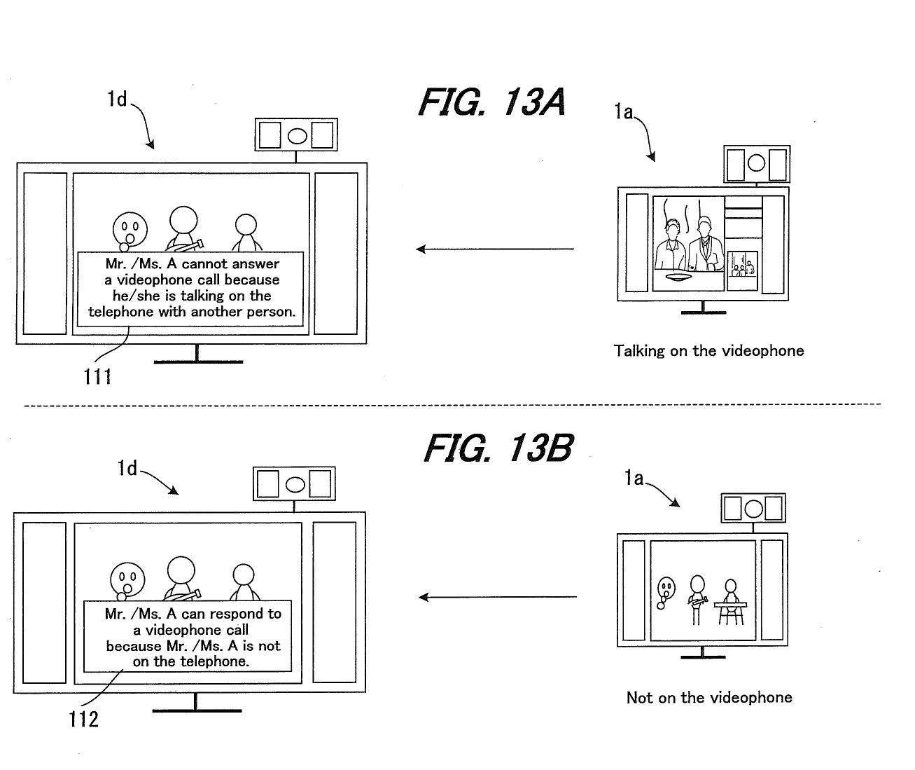

As shown in FIG. 13A, suppose that a user's videophone apparatus 1d is connected to a videophone apparatus 1a belonging to a communication partner, Mr./Ms. A, by way of a network. In Mr./Ms. A's videophone apparatus 1a, set top unit 3 (FIG. 3) functioning as status information acquisition portion 101 (FIG. 1), acquires information indicating “videophone function is in operation” and sends this status information to presence processor 79 (FIG. 9) of adapter unit 4 (FIGS. 3 and 9) functioning as user status information generator 102 (FIG. 1). Presence processor 79 generates user status information “Mr./Ms. A is engaged with another electronic apparatus and cannot response” and sends it to the videophone apparatus 1d (FIG. 13) of the user by way of a network. Controller 73 (FIG. 9) of adapter unit 4 of user's videophone apparatus 1d generates and displays a character indication 111 (FIG. 13) “Mr./Ms. A cannot answer a videophone call because he/she is talking on the telephone with another person”, based on the user status information. Specifically, character indication 111 generated by video processor 82 (FIG. 9) is superimposed on the video from program-video processor 77 in audio and video composer 84 and sent out to television receiver 2. Superimposition of character indication 111 is preferably done with display in the form of a so-called “dialog box” of an opaque, translucent or transparent sectioned area, laid over the television program.

As shown in FIG. 13B, when Mr./Ms. A is not on the videophone, presence processor 79 (FIG. 9) of Mr./Ms. A's videophone apparatus 1a generates user status information “Mr./Ms. A is not using the videophone” and sends it to videophone apparatus 1d. Controller 73 (FIG. 9) of adapter unit 4 of videophone apparatus 1d generates and displays a character indication 112 (FIG. 13) “Mr./Ms. A can respond to a videophone call because Mr./Ms. A is not on the telephone”, based on the user status information.

In this way, the user is able to know whether the person at the other end can respond or not, hence it is possible for the user to make a suitable action such as making a call immediately, postponing making a call, sending an email instead, or other actions.

### Example 2

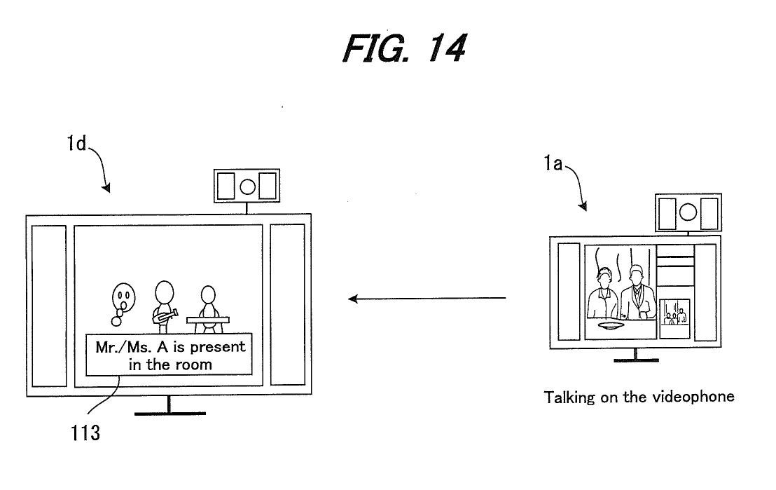

When the apparatus status information message “the telephonic function is in operation” has been sent from set top unit 3 (FIG. 3) of videophone apparatus 1a (FIG. 14) to presence processor 79 (FIG. 9) of adapter unit 4, presence processor 79 generates user status information “Mr./Ms. A is present in the room” because he/she is on the phone. As shown in FIG. 14, the user status information is transmitted to videophone apparatus 1d, where controller 73 (FIG. 9) of adapter unit 4 outputs an indication 113 (FIG. 14) indicating “Mr./Ms. A is present in the room”. When the apparatus status information indicates “telephonic function is not in operation”, there is no evidence of Mr./Ms. A being in the room. So no indication is given, or a character indication showing that Mr./Ms. A is likely to be out of the room may be generated and displayed.

Here, “present in the room” means that the user is present in the vicinity of the videophone apparatus. In describing “vicinity” by a stretch of a numerical value, it can be referred to as an area within a circle of about 5 meters in radius when the videophone apparatus is located at the center. This is based on that fact as the presence of the user is detected by various sensors, which will be described later, the presence of the user can be positively detected within about a 5 meter radius. Generally, the reach of IR remote control is as much as 2 meters. However, if just the input of infrared rays is to be detected without discriminating the IR signal, R/C photoreceiver 25 (FIG. 8) is capable of detecting the input to the IR remote control device at a point about 5 meter forwards therefrom. Further, motion detecting sensor 23 (FIG. 8) has a capability of detecting a motion of an object that is about 10 meters at a maximum away from it, and it is almost unlikely to mis-detect a motion of a person if the person is present within about 5 meters. In addition, the fact that the diagonal of an eight-mat room (3.6 m-square room) is about 5 meters long also supports the basis of the definition of “vicinity”. That is, a person who is in an 8 mat room with a videophone apparatus placed therein may be regarded as being in the vicinity of the videophone apparatus.

Here, if the sensor has a higher detection capability, the definition of “present in the room” may proportionally exceed the above range. For example, the area may be defined as being within a home or a circle of about 10 meters in radius from the videophone.

In this way, the user is able to know whether the person at the other end is present in the vicinity of the videophone apparatus, and if the person at the other end is talking on the phone, it is possible for the user to make a suitable action such as hesitating making a call, sending an email instead, or other actions.

### Example 3

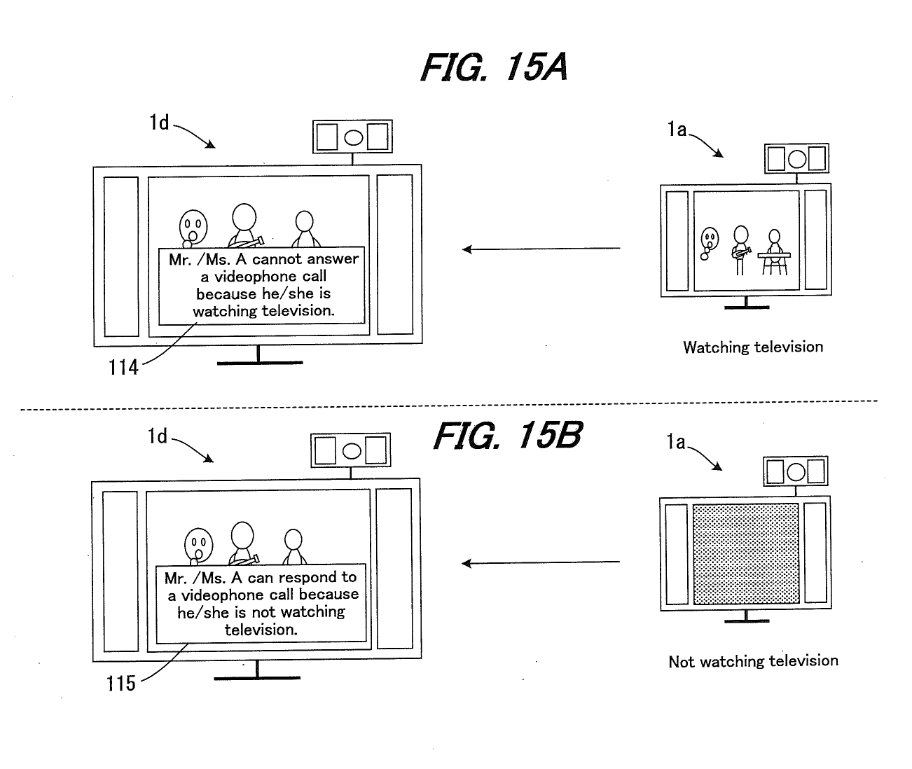

As shown in FIG. 15A, when Mr./Ms. A is watching television, set top unit 3 (FIG. 3) as status information acquisition portion 101 in videophone apparatus 1a, acquires a piece of information that indicates “TV function is in operation”, and sends this status information to presence processor 79 (FIG. 9) of adapter unit 4 as user status information generator 102. Presence processor 79 produces user status information that indicates “Mr./Ms. A is watching television” and transmits it to videophone apparatus 1d (FIG. 15A) by way of a network. Here, in the case of television, the information is generated based on the fact that “TV function is in operation” or “video information is being output”. In the case of an audio listening apparatus, it is possible to generate user status information indicating “Mr./Ms. A is listening audio” based on the fact that “audio is being output”, for example. Controller 73 (FIG. 9) of adapter unit 4 of videophone apparatus 1d (FIG. 15A) generates and displays a character indication 114 (FIG. 15A) “Mr./Ms. A cannot answer a videophone call because he/she is watching television”, based on the user status information. Specifically, character indication 114 generated by video processor 82 (FIG. 9) is superimposed on the video from program-video processor 77 in audio and video composer 84 and is sent out to television receiver 2. Alternatively, presence processor 79 of videophone 1a may generate user status information that indicates “Mr./Ms. A cannot answer a videophone call” based on the status “video information is being output”.

On the other hand, as shown in FIG. 15B, when Mr./Ms. A is not watching television, user status information “Mr./Ms. A is not watching television” is sent from Mr./Ms. A's videophone apparatus 1a. Accordingly, controller 73 (FIG. 9) of adapter unit 4 on the user side generates and displays a character indication 115 (FIG. 15B) “Mr./Ms. A can respond to a videophone call because Mr./Ms. A is not watching television”.

In this way, the user is able to know whether the communication partner at the other end is watching television or not, hence it is possible for the user to make a suitable action such as hesitating making a call so as not to disturb them TV watching if the purpose of the call is not urgent.

### Example 4

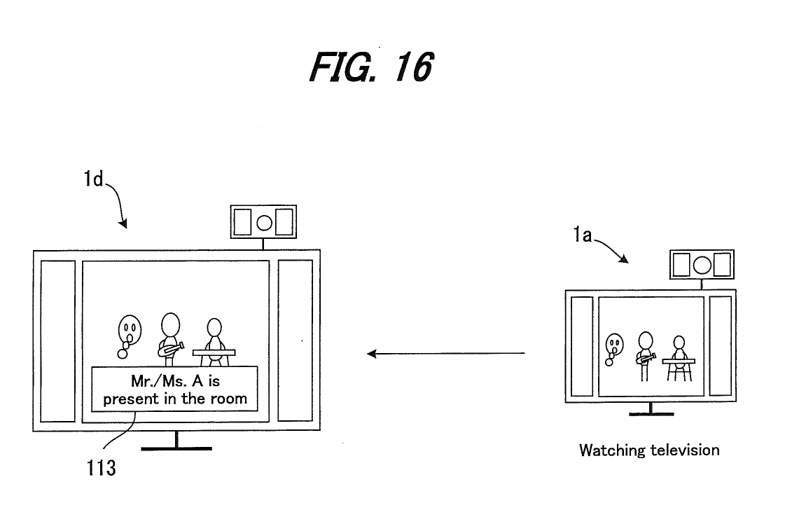

As another example, as shown in FIG. 16, in videophone apparatus 1a, presence processor 79 (FIG. 9) of adapter unit 4 generates user status information “Mr./Ms. A is in the room” from the apparatus status information “TV function is in operation”. Here, in the case of television, the information is generated based on the fact that “TV function is in operation” or “video information is being output”. In the case of an audio listening apparatus, it is possible to generate user status information “Mr./Ms. A is in the room” based on the fact that “audio is being output”. This user status information is transmitted to videophone apparatus 1d, where controller 73 of adapter unit 4 generates and displays a character indication 113 (FIG. 16) indicating “Mr./Ms. A is in the room”. When “the television function is not in operation”, there is no evidence of Mr./Ms. A being in the room. So no indication is given, or a character indication showing that Mr./Ms. A is likely to be out of the room may be generated and displayed.

### Example 5

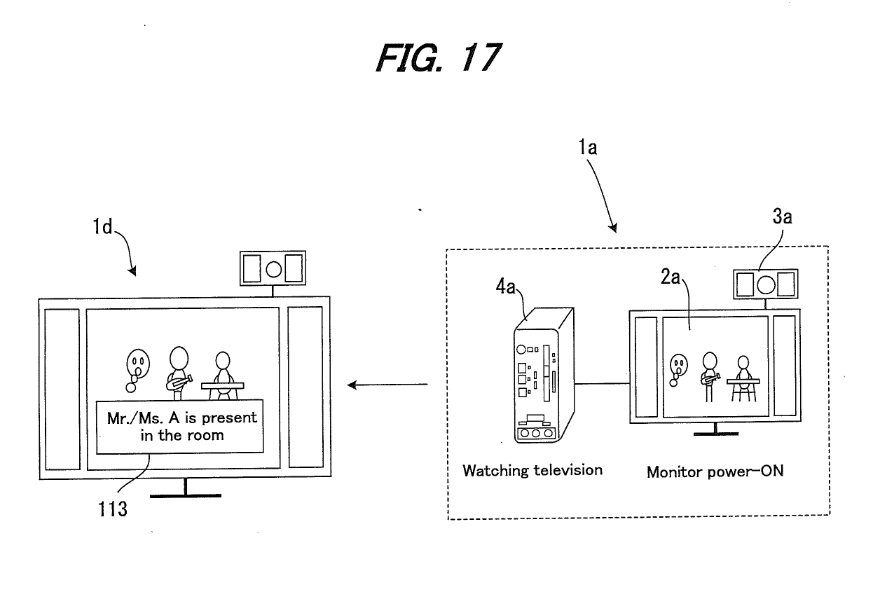

In this example, it is assumed that videophone apparatus 1a is formed of, at least, two separate units, i.e., television receiver 2a and adapter unit 4a as shown in FIG. 17. As a means for detecting “the television function is in operation” the power supply plug of television receiver 2a of videophone apparatus 1a is connected to TV receiver power supply tap 39 (FIG. 6) in adapter unit 4a so that the current flowing through TV receiver power supply tap 39 is detected by a power-supply current detector 85 (FIG. 9). Status information “the television receiver is activated” is sent to presence processor 79 when power-supply current detector 85 of adapter unit 4 detects a current equal to or greater than the predetermined level. Here, the phrase “a current equal to or greater than the predetermined level” is given considering the standby current. As presence processor 79 receives status information “the television receiver is activated”, it generates user status information “Mr./Ms. A is in the room”. This information is sent to videophone apparatus 1d (FIG. 17), where controller 73 (FIG. 9) of adapter unit 4 generates and displays an indication 113 (FIG. 17) indicating “Mr./Ms. A is in the room”. Here, instead of determining whether the television function is in operation or not based on the current supply of equal to or greater than the predetermined level to power supply plug of television receiver 2a, it is possible to make a judgement based on whether an audio or video signal from audio and video processor 74 (FIG. 9) is output from audio and video composer 84.

### Example 6

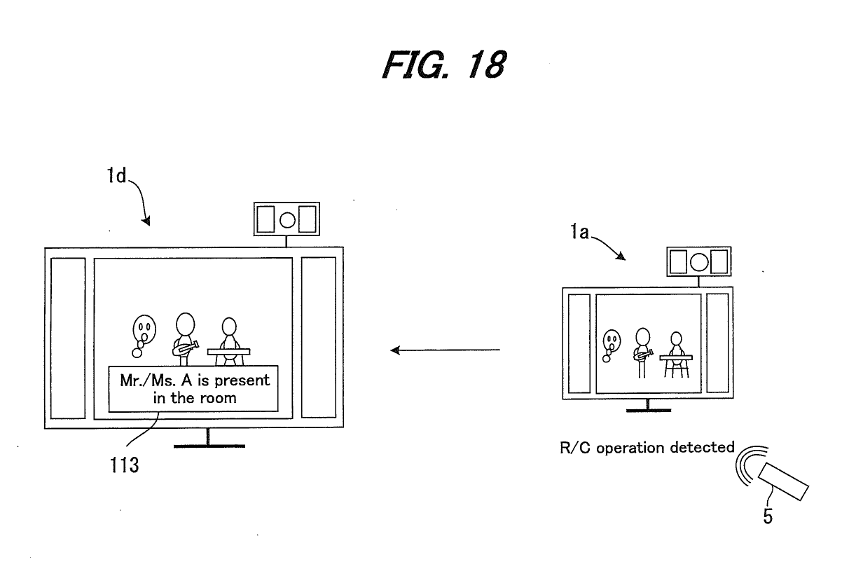

As shown in FIG. 18, when Mr./Ms. A is operating R/C device 5, R/C photoreceiver 13 (FIG. 8) of set top unit 3 in videophone apparatus 1a detects infrared rays from R/C device 5, and sends the detection to presence processor 79 (FIG. 9) of adapter unit 4. Presence processor 79 generates user status information indicating “Mr./Ms. A is in the room” and sends it out to videophone apparatus 1d (FIG. 18) via a network. Controller 73 (FIG. 9) of adapter unit 4 in user's videophone apparatus 1d generates and displays a character indication 113 (FIG. 18) indicating “Mr./Ms. A is in the room” based on the user status information. Specifically, the character indication 113 generated by video processor 82 (FIG. 9) is superimposed on the video from program-video processor 77 in audio and video composer 84 and sent out to television receiver 2. When no R/C operation is detected, there is no evidence of Mr./Ms. A being in the room. So no indication is given, or a character indication showing that Mr./Ms. A is likely to be out of the room may be generated and displayed.

### Example 7

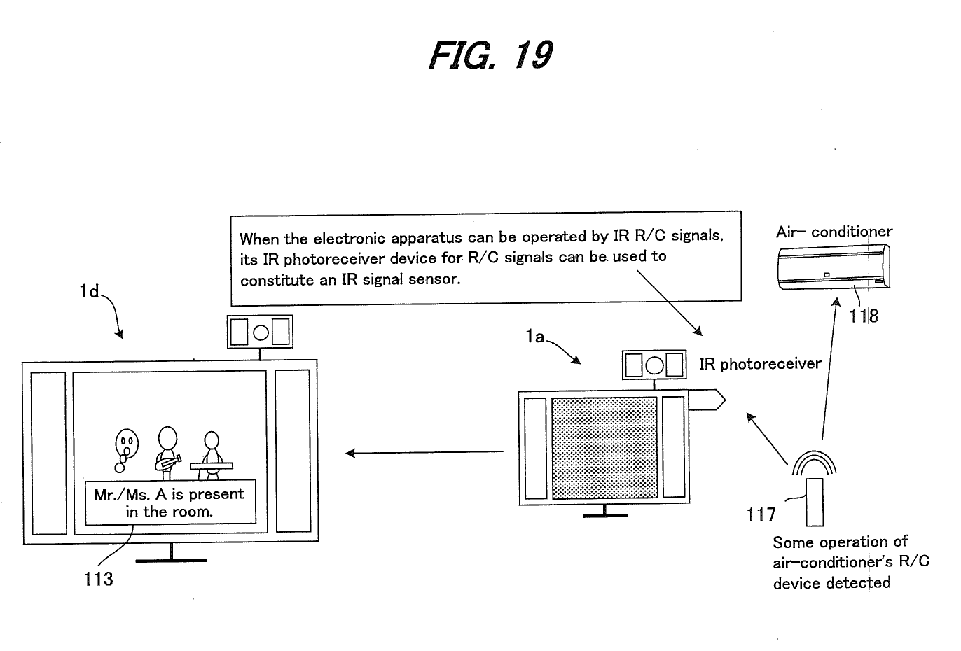

As shown in FIG. 19, when Mr./Ms. A is operating a R/C device 117 for an air conditioner 118, R/C photoreceiver 13 (FIG. 8) of set top unit 3 detects infrared rays from R/C device 117, and sends the detection to presence processor 79 (FIG. 9) of adapter unit 4. Presence processor 79 generates user status information indicating “Mr./Ms. A is in the room” and sends it out to user's videophone apparatus 1d (FIG. 19) via a network. Controller 73 (FIG. 9) of adapter unit 4 in videophone apparatus 1d generates and displays a character indication 113 indicating “Mr./Ms. A is in the room” based on the user status information. Specifically, the character indication 113 generated by video processor 82 is superimposed on the video from program-video processor 77 in audio and video composer 84 and sent out to television receiver 2. When no R/C operation is detected, there is no evidence of Mr./Ms. A being in the room. So no indication is given, or a character indication showing that Mr./Ms. A is likely to be out of the room may be generated and displayed.

Though description herein with FIG. 19 is made taking an example of R/C device 117 of air-conditioner 118, any R/C device such as for video recorders, stereo sets, DVD players and others is applicable as long as it makes control using infrared rays. Alternatively, instead of R/C photoreceiver 25, a device that receives and measures electric waves may be used to detect a R/C operation using electric waves. This example is aimed at making a judgement as to whether Mr./Ms. A is in the room or not by monitoring a R/C signal emitted by Mr./Ms. A to make control of the appliances other than videophone 1a, hence variations made within the scope that meets this object should be regarded as being within the scope of the present invention.

### Example 8

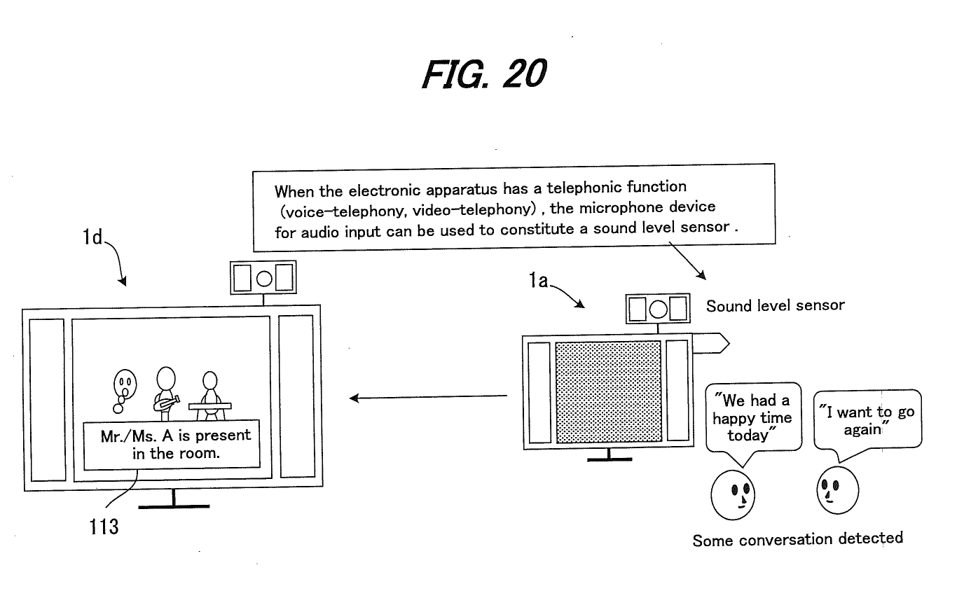

As shown in FIG. 20, when Mr./Ms. A is talking around videophone apparatus 1a, microphone 22 (FIG. 8) of set top unit 3a detects the sound level. When the detection exceeds the fixed sound level, the resultant is sent to presence processor 79 of adapter unit 4 (FIG. 9). Presence processor 79 generates user status information indicating “Mr./Ms. A is in the room” and sends it out to user's videophone apparatus 1d (FIG. 20) via a network. Controller 73 (FIG. 9) of adapter unit 4 in user's videophone apparatus 1d generates and displays a character indication 113 indicating “Mr./Ms. A is in the room” based on the user status information. Specifically, the character indication 113 generated by video processor 82 is superimposed on the video from program-video processor 77 in audio and video composer 84 and sent out to television receiver 2. When sound input at a level greater than the fixed sound level is not detected, there is no evidence of Mr./Ms. A being in the room. So no indication is given, or a character indication showing that Mr./Ms. A is likely to be out of the room may be generated and displayed. Here, instead of using microphone 22, a separate sound level sensor may be provided for sound detection. Also, the target of sound detection is not limited to the conversation of the user. It is also possible to generate user status information indicating “Mr./Ms. A is in the room” by detecting the sound from a television apparatus or from an audio listening apparatus. However, since microphone 22 that is used for audio input of video-telephony or voice-telephony may be used for sound detection without providing an extra sound level sensor, this makes it possible to cut down the cost of adapter unit 4.

### Example 9

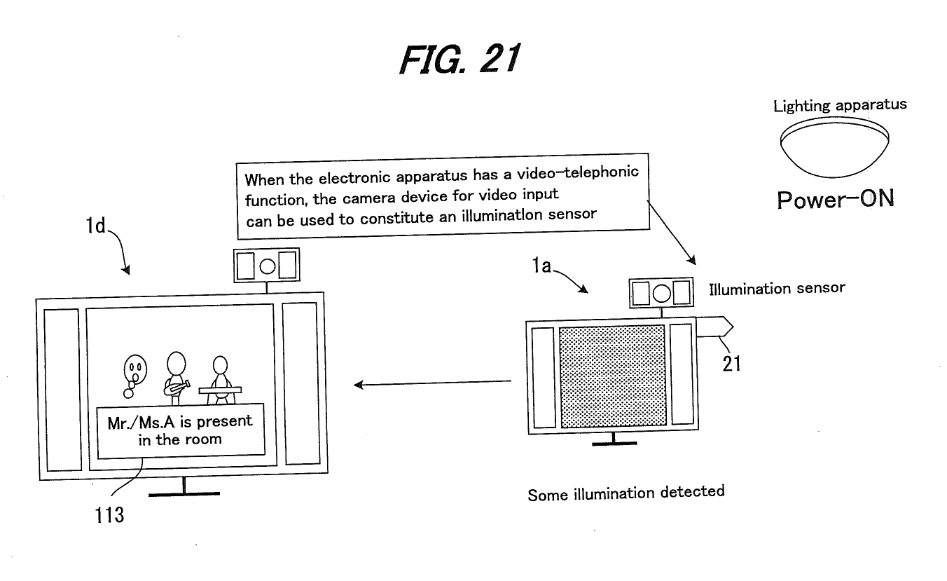

As shown in FIG. 21, when camera 21 (FIG. 8) serving as an illumination sensor of set top unit 3 detects illumination exceeding the predetermined level, the detection is sent to presence processor 79 (FIG. 9) of adapter unit 4. Detection of illumination can be made using a method of examining the brightness of the pixels that constitute the image shot by camera 21, for example. Then, presence processor 79 generates user status information indicating “Mr./Ms. A is in the room” and sends it out to user's videophone apparatus 1d (FIG. 21) via a network. Controller 73 (FIG. 9) of adapter unit 4 in videophone apparatus 1d generates and displays a character indication 113 indicating “Mr./Ms. A is in the room” based on the user status information. Specifically, the character indication 113 generated by video processor 82 is superimposed on the video from program-video processor 77 in audio and video composer 84 and sent out to television receiver 2. When no illumination equal to or greater than the predetermined level is detected, there is no evidence of Mr./Ms. A being in the room. So no indication is given, or a character indication showing that Mr./Ms. A is likely to be out of the room may be generated and displayed. Here, instead of using camera 21, a separate illumination sensor may be provided for illumination detection. However, since camera 21 that is used for video input of video-telephony may be used for illumination detection without providing an extra illumination sensor, this makes it possible to cut down the cost of adapter unit 4.

### Example 10

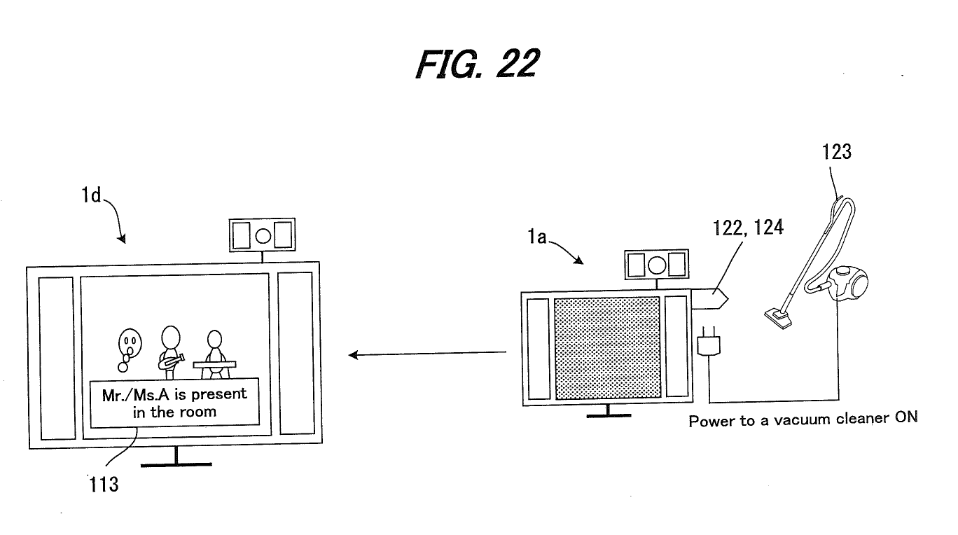

As shown in FIG. 22, in videophone apparatus 1a, a power-supply plug of another electronic appliance such as a vacuum cleaner 123 is connected to a power-supply tap 124 with a current sensor 112 (assume that this is provided for the TV receiver, for example), so that the current through power supply tap 124 can be detected. This detected information is arranged to be sent to presence processor 79 (FIG. 9) of adapter unit 4. Presence processor 79 generates user status information indicating “Mr./Ms. A is in the room” based on the fact “another electronic appliance is in operation”, and sends it out to a user's videophone apparatus 1d (FIG. 22) via a network. Controller 73 (FIG. 9) of adapter unit 4 in videophone apparatus 1d generates and displays a character indication 113 indicating “Mr./Ms. A is in the room” based on the user status information. Specifically, the character indication 113 generated by video processor 82 is superimposed on the video from program-video processor 77 in audio and video composer 84 and sent out to television receiver 2. When no current is detected in power-supply tap 124, there is no evidence of Mr./Ms. A being in the room. So no indication is given, or a character indication showing that Mr./Ms. A is likely to be out of the room may be generated and displayed.

Though description herein with FIG. 22 is made taking an example of a vacuum cleaner, any electronic appliance such as an iron, game machine and the like is applicable as long as the electronic appliance needs to be operated by a person residing therein. Conversely, refrigerators, video recorders having a preset recording function and the like do not meet the purpose of the present invention because they are not the electronic appliances that must be operated by a person nearby. This example is aimed at making a judgement as to whether Mr./Ms. A is in the room or not by monitoring a current flowing in an electronic appliance when it is operated by Mr./Ms. A residing nearby. So, variations made within the scope that meets this object should be regarded as being within the scope of the present invention.

### Example 11

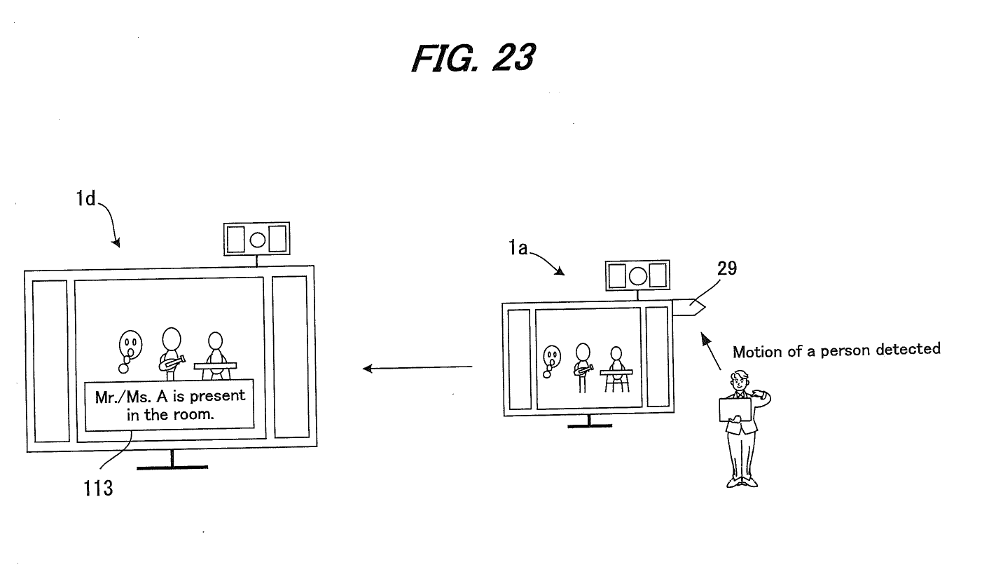

As shown in FIG. 23, when motion sensor 23 (FIG. 8) of set top unit 3 of videophone apparatus 1a detects the motion of a person, the detection is sent to presence processor 79 (FIG. 9) of adapter unit 4. Presence processor 79 generates user status information indicating “Mr./Ms. A is in the room” and sends it out to user's videophone apparatus 1d (FIG. 23) via a network. Controller 73 (FIG. 9) of adapter unit 4 in videophone apparatus 1d generates and displays a character indication 113 indicating “Mr./Ms. A is in the room” based on the user status information. Specifically, the character indication 113 generated by video processor 82 (FIG. 9) is superimposed on the video from program-video processor 77 in audio and video composer 84 and sent out to television receiver 2. When no motion is detected, there is no evidence of Mr./Ms. A being in the room. So no indication is given, or a character indication showing that Mr./Ms. A is likely to be out of the room may be generated and displayed.

In this way, according to the examples 4 to 11, it is possible for the user to know whether the person at the other end is in the room or not, hence it is possible for the user to make a suitable action when making a call.

### Example 12

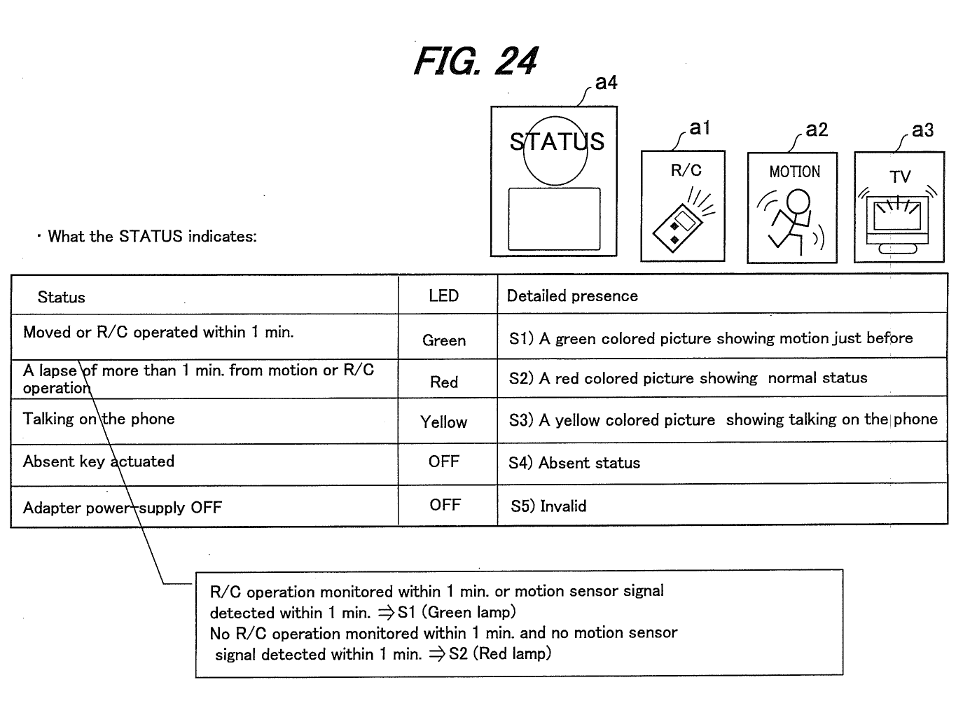

Various statuses information acquired from status information acquisition portion 101 is sent to presence processor 79 (FIG. 9), where user status information is generated based on the status information, as stated heretofore. At this point, the status information is transmitted from videophone apparatus 1a to videophone apparatus 1d, and controller 73 (FIG. 9) of adapter unit 4 of videophone apparatus 1d causes the corresponding presence indicator 33 to inform the user of the current status by selecting one from different colors, as shown in FIG. 24.

Detailedly, when no person is allotted to a presence indicator 33, the presence indicator 33 is turned off. When the absent status has been set by the absent key 34 (FIG. 6) of videophone apparatus 1a, or when the adapter is deactivated, presence indicator 33 is off (S4).

When the absent status has been cancelled by absent key 34 of videophone apparatus 1a and when videophone apparatus 1a is being used for telephonic communication, the presence indicator 33 illuminates with yellow color (S3).

When the absent status has been cancelled by absent key 34 of videophone apparatus 1a and when videophone apparatus 1a is not being used for telephonic communication, the presence indicator 33 illuminates with green or red color (S1, S2). The indicator illuminates with green color when less than one minute has lapsed after motion detecting sensor 23 of videophone apparatus 1a detected motion, or when less than one minute has lapsed after R/C photoreceiver 25 of videophone apparatus 1a detected an IR signal. The indicator illuminates with red color when one minute or longer time has lapsed after motion detecting sensor 23 of videophone apparatus 1a detected motion and when one minute or longer time has lapsed after R/C photoreceiver 25 of videophone apparatus 1a detected an IR signal.

However, since only a few kinds of status can be displayed using the colors of presence indicator 33, icons may be displayed on television receiver 2 as shown in FIG. 24, in order to provide various statuses information. Specifically, an R/C icon a1 represents the IR signal detection status by R/C photoreceiver 25 of videophone apparatus 1a; a motion icon a2 represents the motion detection status by motion detecting sensor 23 of videophone apparatus 1a; a TV-icon a3 represents the current detection status by power-source current detector 85 of videophone apparatus 1a; and a status a4 represents the total status of the user of videophone apparatus 1a. The colors of the status icons may vary in the same manner as presence indicator 33.

### Example 13

Since only a few kinds of status can be displayed using the colors of presence indicator 33, it is possible to increase the number of kinds of status by flashing presence indicator 33, as shown in FIG. 25. For example, different states may be indicated, by flashing 3 times every unit time when the television is activated, by flashing once every unit time when R/C operation is made once, by flashing slowly (varying the flashing interval) when motion of a person is detected, and the like.

In this way, it is possible for the user to know the type of status information acquired by the status information acquisition portion, so that the user is able to easily grasp the situation hence make a suitable action when making a call.

### Example 14

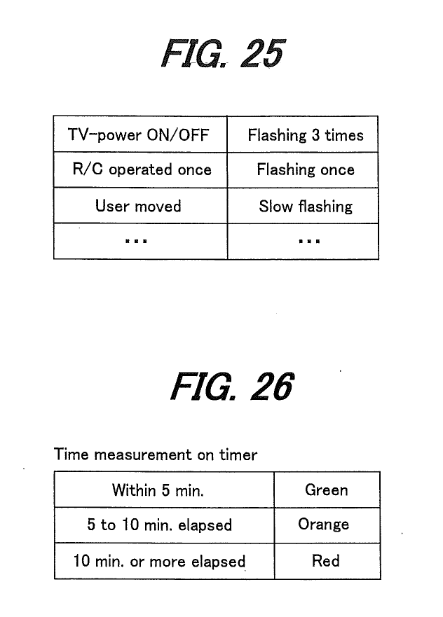

A person is highly likely to stay near the apparatus within a fixed period of time after when presence processor 79 (FIG. 9) generated user status information “presence in the room” that indicates that a person is near the apparatus. This can be displayed by presence indicator 33 of adapter unit 4. As shown in FIG. 26, because the person is highly likely to be still in the room if within 5 minutes, presence indicator 33 is adapted to illuminate with green color. After a lapse of 5 to 10 minutes, the possibility of the person being present in the room lowers, so the indicator is adapted to illuminate with orange color. After a lapse of 10 minutes or longer, the indicator is adapted to illuminate with red color, presuming that their person is not present in the room.

In this way, the user is informed of the presence status of the person at the other endpoint, so that it is possible for the user to make a suitable action when making a call.

### Example 15

As shown in FIG. 27, the user status information generated by presence processor 79 (FIG. 9) of each adapter unit 4 of electronic apparatus 1a, 1b and 1c is transmitted to electronic apparatus 1d. Controller 73 of adapter unit 4 of electronic apparatus 1d, based on these transmitted user statuses information, turns on presence indicators 33 of adapter unit 4. Though, in the description with FIG. 27, presence indicators 27 are arranged on the top of television receiver 2 for convenience sake, they can be arranged elsewhere. As an example, as shown in FIG. 27, if the ON/OFF detection of the television power supply presents the power-ON state, presence indicator 33 is turned on. When the detection presents the power-OFF state, presence indicator 33 is not turned on. At the same time, the status of each apparatus is displayed as information 113 (FIG. 27) on the television receiver 2.

### Example 16

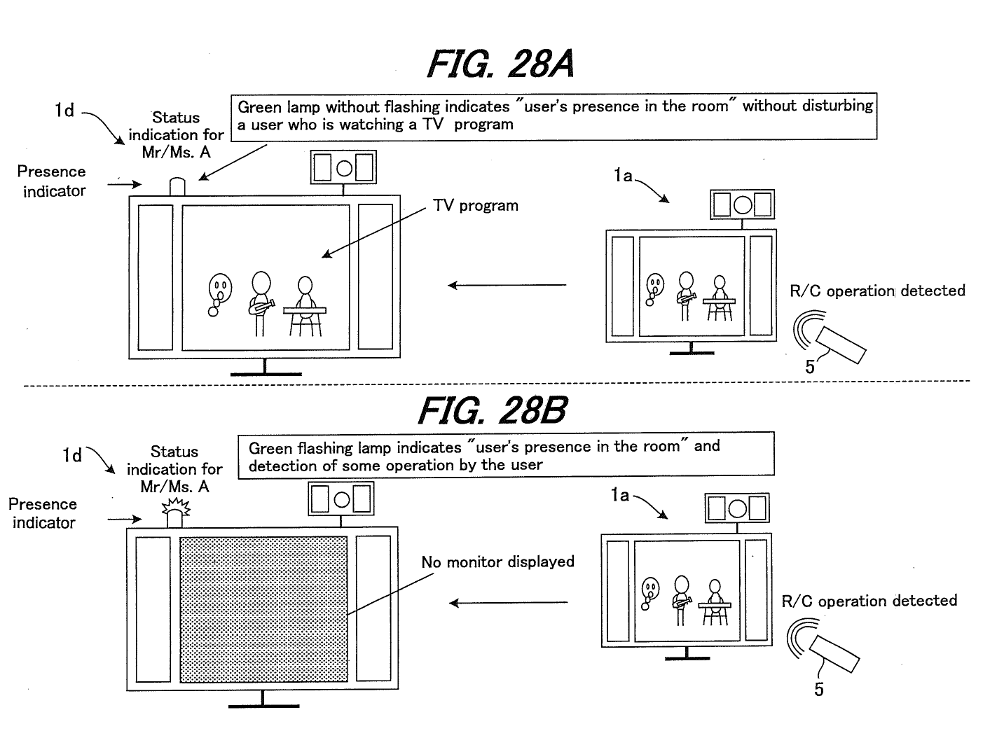

For example, as shown in FIG. 28, user's status information (either present or not in the room) is determined based on detection of some operation of remote control device 5. Based on this result, presence information is displayed. At this point, if the user is watching a TV program on electronic apparatus 1d, presence indicator 33 is turned on with green color but does not flash. Because flashing is effective in calling user's attention but might disturb the user while enjoying a TV program. Therefore, when the user is watching a TV program as shown in FIG. 28A, presence indicator 33 is adapted not to turn on and off, so that the user will not be interrupted while TV watching.

As shown in FIG. 28B, when no TV program is viewed with television receiver 2, the status indication is given by flashing the presence indicator 33 in order to call user's attention.

In this way, user status information is given to the user by differentiating the way that presence indicator 33 gives indication in accordance with the status of television receiver 2 being used, hence deliberate notice can be given to the user.

### Example 17

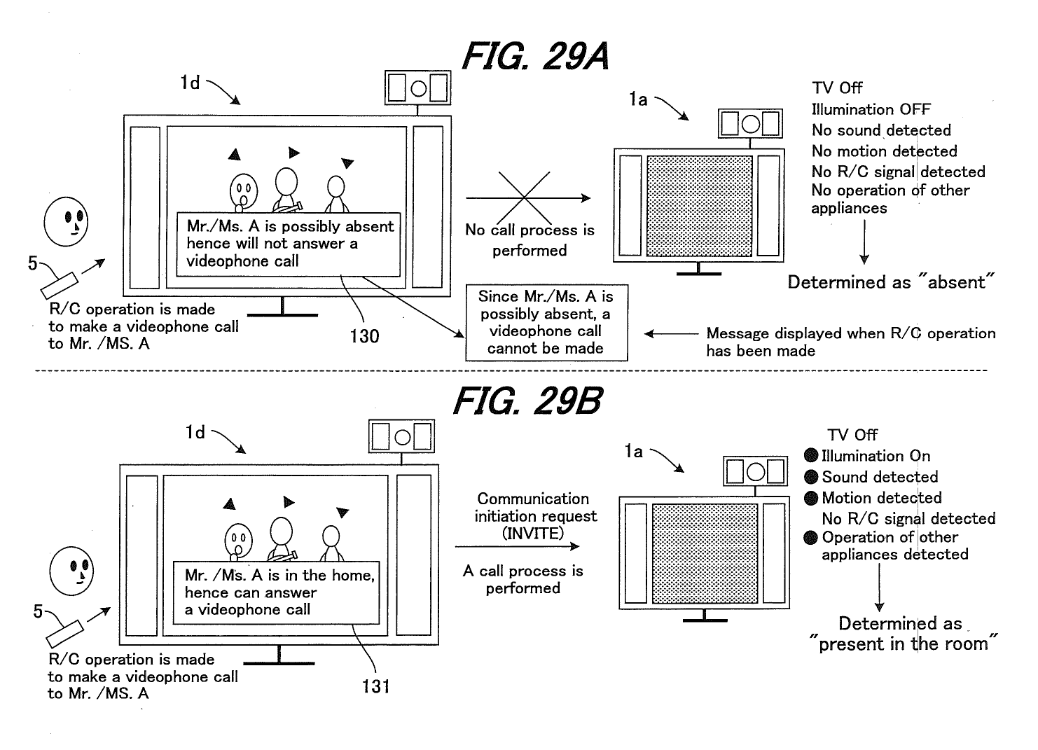

As shown in FIG. 29, presence processor 79 (FIG. 9) of adapter unit 4 generates user status information from a plurality of statuses information. This configuration enables more exact judgement compared to the case where user status information is generated from a single status information. Illustratively, suppose that as shown in FIG. 29B, a plurality of statuses information of electronic apparatus 1a are given as “power-OFF of the television” and “no detection of R/C signals” which indicate high possibility of user's absence, and “power-ON of the illumination”, “sound detected” and “operation of another appliance detected” which indicate high possibility of the user's presence in the room. In this case, based on these status information, the presence processor generates the final user status information indicating “the user is present”, by weighting each piece of status information appropriately.

When presence processor 79 of adapter unit 4, based on each status information, has generated the user status information indicating “the user on the other side is present” as shown in FIG. 29B, controller 73 of adapter unit 4 causes call control processor 80 (FIG. 9) to perform a call procedure. Whether a call procedure should be made or not is determined by controller 73.

On the other hand, when the user status information indicating that the user on the other side is absent, has been obtained, controller 73 of adapter unit 4 outputs an indication 130 indicating “Mr./Ms. A is absent, hence will not answer a videophone call” (FIG. 29A). In addition, the controller prohibits call control processor 80 from making a call procedure. As a result, even if the user tries to make a call, the apparatus by itself will not operate. It is possible to configure the system such that, when the user status information indicating that the user on the other side is absent has been obtained, the apparatus disables not only the call procedures for video-telephony that exchanges audio and video by two-way communication but also all the call procedures including voice calls that enable transmission of audio by one-way communication as voice call key 50 (FIG. 7) is pressed. (The telephonic communication-setup deciding portion corresponds to the controller 73 that makes this judgement.) It is further possible to configure the system such that, when the user status information indicating that the user on the other side is absent has been obtained, the apparatus prohibits a call that will establish itself without any other-end user's instruction but permits a video-telephonic call that will establish itself when the other-end user makes a certain operation after the ringing. (The telephonic communication-setup deciding portion corresponds to the controller 73 that makes this judgement.)<

### Example 18

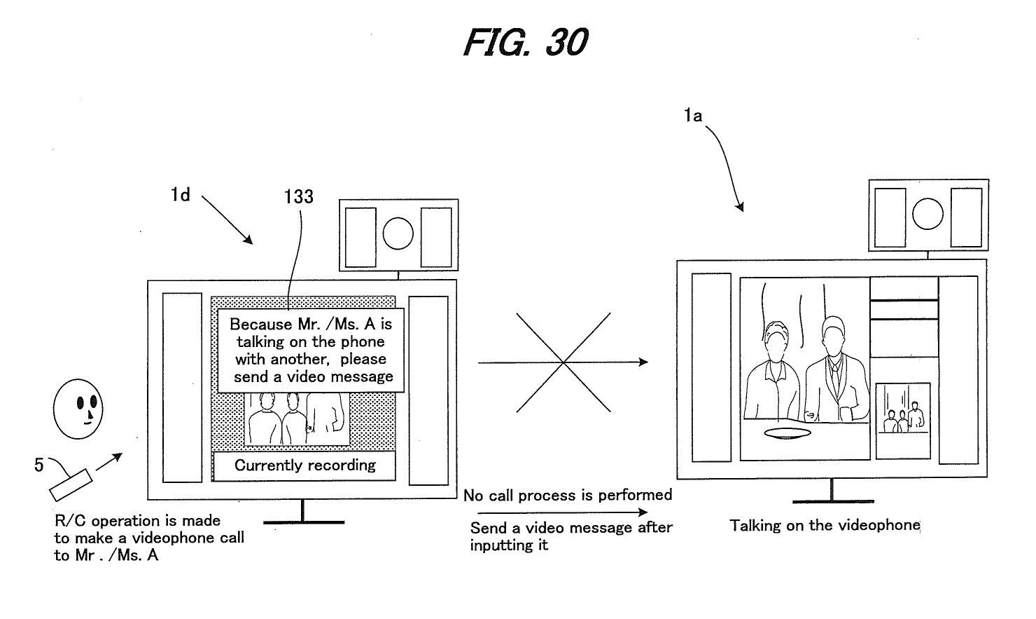

As shown in FIG. 30, presence processor 79 of adapter unit 4 generates user status information from a plurality of statuses information. When user status information indicating “response-disabled”, “absent” or “unlikely to be present” has been acquired, controller 73 prohibits call control processor 80 from making a call, similarly to the above example. Then, controller 73 starts a process of transmitting a video message (the message transmitter). For example, the controller actuates a video message application with the address of the partner's videophone apparatus 1 set up as recipient information. This configuration makes it possible for the user to leave a message to the other end and secure smooth communication though direct communication at that point is not permitted.

Electronic apparatus 100, status information acquisition apparatus 105 and status information presenting apparatus 106 in the present embodiment are substantially realized by hardware for performing a program as well as a conventional computer, a computer program which is performed by the hardware and data which is stored in the hardware.

What is claimed is:

1. An electronic apparatus comprising:
a presence information generator for generating a presence information indicating whether or not a user of the electronic apparatus is in a room or a home in which the electronic apparatus is placed,
a power supply outlet for supplying power to another electronic appliance, and
a power supply status detector for detecting a state of power supply being supplied to the another electronic appliance by the power supply outlet,
wherein
the presence information generator generates the presence information in accord with the state of power supply to the another electronic, obtained by the power supply status detector.

2. The electronic apparatus according to claim 1, wherein the power supply status detector detects a state of power supply to an electronic appliance being operated by the user.

3. The electronic apparatus according to claim 1, wherein the power supply outlet is provided with the power supply status detector.
